(19) United States
(12) Patent Application Publication
(10) Pub. No.: US 2025/0141751 A1
(43) Pub. Date: May 1, 2025

(54) EDGE CLOUD WORKLOAD PLACEMENT IN A MULTITIER EDGE CLOUD

(71) Applicant: Meta Platforms, Inc., Menlo Park, CA (US)

(72) Inventors: YuLing Chen, Fremont, CA (US); Matthew Calder, Seattle, WA (US); Ayush Jain, BURIEN, WA (US); Supratim Deb, Fremont, CA (US); Lee Mark Hetherington, Orinda, CA (US); Huapeng Zhou, Mountain View, CA (US); Benjamin Vallis, Mountain View, CA (US); Wen Liu, San Jose, CA (US)

(73) Assignee: Meta Platforms, Inc., Menlo Park, CA (US)

(21) Appl. No.: 18/384,278

(22) Filed: Oct. 26, 2023

(51) Int. Cl. H04L 41/122; H04L 43/0864

(52) U.S. Cl. CPC H04L 41/122; H04L 43/0864

(57) ABSTRACT

In some embodiments, a computer-implemented method includes ascertaining a multitier topology representation of an edge cloud network; generating a pseudo node topology representation of the edge cloud network from the multitier topology representation; and utilizing the pseudo node topology representation of the edge cloud network to ascertain minimum-latency pseudo-node-based edge cloud clusters (ECCs), the minimum-latency pseudo-node-based ECCs being utilized to minimize a latency of user requests routed through the edge cloud network from a user of the edge cloud network. In some embodiments of the computer-implemented method, the minimum-latency pseudo-node-based ECCs are ascertained based upon a pseudo-node-based round-trip-times (RTTs) assessment from the user of the edge cloud network, the user requests being routed to the minimum-latency pseudo-node-based ECCs ascertained using the pseudo node topology representation.

### BACKGROUND

In recent years, a new generation of cloud native applications have emerged in advanced high-end computational applications, such as, for example, augmented reality (AR), virtual reality (VR), autonomous vehicle navigation, and cloud gaming. The cloud-native applications are compute-intensive and latency sensitive and thus, the quality of experience (QoE) is of vital importance for users of the cloud native applications. Traditional centralized cloud architectures often do not meet QoE expectations for cloud native applications, and, as a result, many users of cloud native applications have become distraught by the overall diminished QoE. In order to improve the QoE for cloud native applications, compute and storage cloud resources have moved closer to the edge of the network where content may be both created and consumed by the end user of the edge cloud. Thus, a cloud architecture is needed that provides edge cloud applications with high performance and throughput.

### BRIEF DESCRIPTION OF THE DRAWINGS

FIG. 1 illustrates a block diagram of an edge cloud network in accordance with some embodiments.

FIG. 2 illustrates a block diagram of a processing system that may be utilized in the edge cloud network of FIG. 1 in accordance with some embodiments.

FIG. 3A illustrates a block diagram of a demand clustering-based workload placement system of FIG. 2 in accordance with some embodiments.

FIG. 3B illustrates an end-to-end (E2E) architecture of the demand forecasting and demand clustering performed utilizing a demand forecasting and clustering unit of FIG. 3A in accordance with some embodiments.

FIG. 4 illustrates a demand clustering unit of the demand clustering-based workload placement system of FIG. 3A in accordance with some embodiments.

FIG. 5A illustrates an edge cloud cluster (ECC) selection unit of the demand clustering unit of FIG. 4 in accordance with some embodiments.

FIG. 5B illustrates a multitier topology of an edge cloud network in accordance with some embodiments.

FIG. 5C illustrates a pseudo node topology of the multitier topology of FIG. 5B in accordance with some embodiments.

FIG. 5D illustrates the pseudo node topology representation of FIG. 5C in further detail in accordance with some embodiments.

FIG. 5E illustrates the pseudo node topology of FIG. 5C in further detail in accordance with some embodiments.

FIG. 5F illustrates an ECC selection method utilized by the demand clustering-based workload placement system of FIG. 3A in accordance with some embodiments.

FIG. 6A illustrates an internet protocol (IP) prefix clustering unit utilized in the demand clustering unit of FIG. 4 in accordance with some embodiments.

FIG. 6B illustrates IP prefix clustering network aggregate (NetAgg) generation method in accordance with some embodiments.

FIG. 7A illustrates a demand NetAggs adjustment unit of the demand clustering unit of FIG. 4 in accordance with some embodiments.

FIG. 8 illustrates an end-to-end (E2E) demand clustering method in accordance with some embodiments.

### DETAILED DESCRIPTION

The following terms are defined to assist in the understanding of various embodiments described herein.

In some embodiments, computing devices 110 are computing devices configured to communicate in an edge cloud network 100. For example, in some embodiments, the edge cloud network 100 includes computing devices 110 in communication with edge cloud clusters (ECCs) 130 via edge point-of-presences (PoPs) 120. In some embodiments, the computing devices 110 may be, for example, a head mounted device (HMD), a laptop, a wearable computer, a personal computer, mobile phone, a server, a tablet, or any other computing device configured to communicate with the edge cloud network 100.

In some embodiments, a user session refers to user session between, for example, a computing device and a service or application hosted in the edge cloud network 100.

In some embodiments, a user session request refers to, for example, a user session request or action initiated by a computing device of computing devices 110 during a user session. In some embodiments, user session requests may include, for example, web page requests, data retrieval requests, authentication requests, database queries, or any other form of communication between a computing device and the edge cloud service.

In some embodiments, an internet protocol (IP) prefix is an IP prefix associated with a user session request since, for example, when a user session request is received from a computing device of computing devices 110, the user session request may be associated with an IP address of the computing device and, by extension, with an IP prefix that represents the network or subnet of the computing device.

In some embodiments, an edge cloud workload is workload associated with an IP prefix in edge cloud network 100.

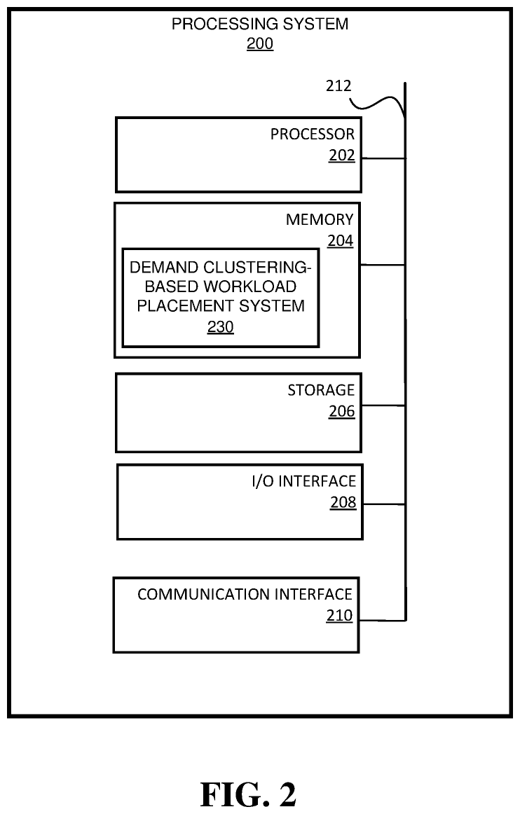

In some embodiments, edge PoPs 120 are PoPs located on an edge of edge cloud network 100 that, in addition to being utilized to perform traditional edge PoP operations in edge cloud network 100, may be configured to perform demand clustering-based cloud workload placement operations described herein. In some embodiments, edge PoPs 120 may include, for example, edge PoP 121-edge PoP 124, wherein each edge PoP of edge PoPs 120 may include edge PoP servers configured to execute the demand clustering-based cloud workload placement operations described herein. In some embodiments, each edge PoP of edge PoPs 120 may include edge PoP servers, processors, networking components, and/or data stores operating to facilitate the operations described herein. In some embodiments, edge PoPs 120 utilize the demand clustering-based workload placement system (illustrated by way of example in FIG. 2) to place edge compute workloads on, for example, ECCs of ECCs 130 selected utilizing the demand clustering-based cloud workload placement operations described herein.

In some embodiments, ECCs 130 are edge cloud clusters that, in addition to being configured to perform traditional edge cloud cluster operations for edge cloud network 100, may be configured to perform demand clustering-based cloud workload placement operations described herein. In some embodiments, ECCs 130 are located in close proximity to, for example, computing devices 110 of edge cloud network 100. In some embodiments, the ECCs 130 include ECC 131-ECC 134 and are a collection of interconnected computing resources, including servers, storage devices, and networking infrastructure, deployed at edge cloud network 100. In some embodiments, the ECCs of ECCs 130 include a cluster of servers capable of processing and executing various tasks and edge compute workloads. In some embodiments, the computing resources may include CPUs (Central Processing Units), GPUs (Graphics Processing Units), specialized accelerators, and memory/storage devices. In some embodiments, ECCs 130 enable edge computing or edge cloud computing, which may refer to the execution of data processing and computation tasks at the edge of the network, closer to the data source.

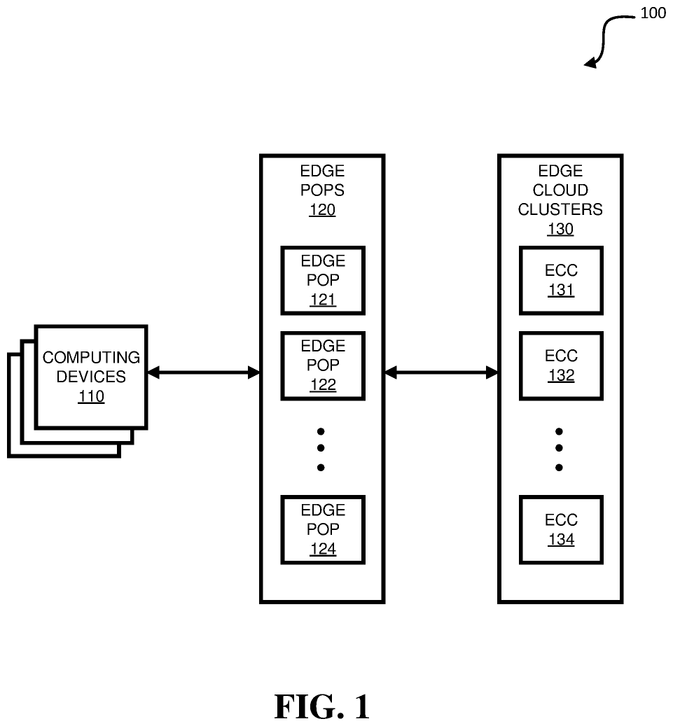

FIG. 1 is a block diagram illustrating an edge cloud network 100 in accordance with some embodiments. In some embodiments, the edge cloud network 100 includes computing devices 110 in communication with edge cloud clusters (ECCs) 130 via edge point-of-presences (PoPs) 120. In some embodiments, the edge cloud network 100 is an edge cloud network that is configured to utilize demand clustering-based edge cloud workload placement operations to efficiently place and schedule edge cloud workloads in demand-cluster-selected ECCs of ECCs 130 of edge cloud network 100. In some embodiments, demand-cluster-selected ECCs are ECCs selected from ECCs 130 for edge cloud workload placement by demand clustering-based edge cloud workload placement system 230, described further herein.

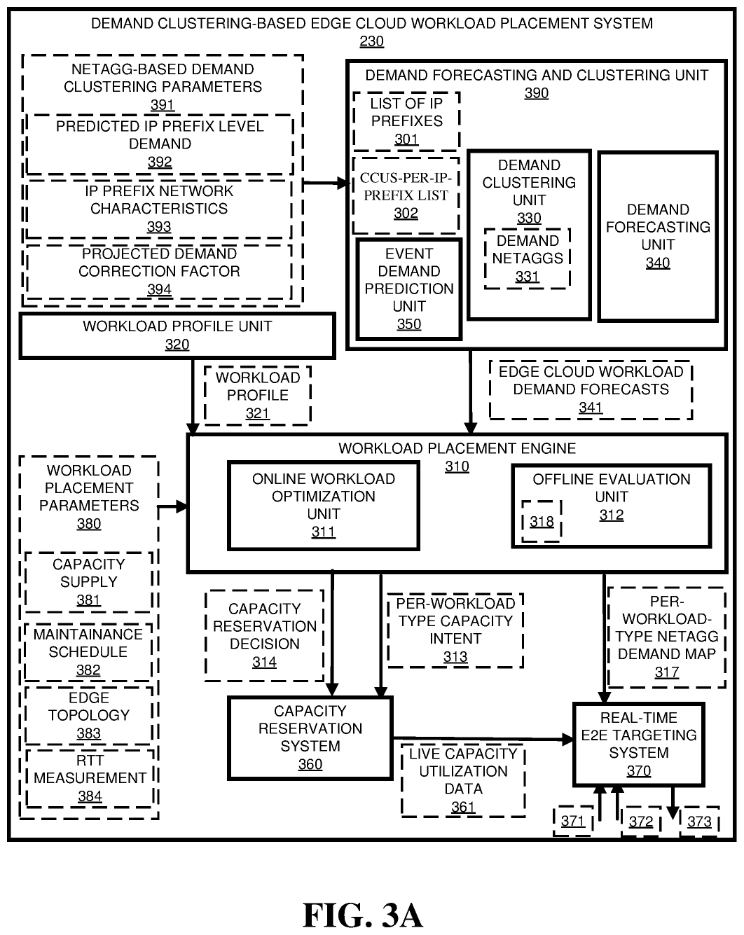

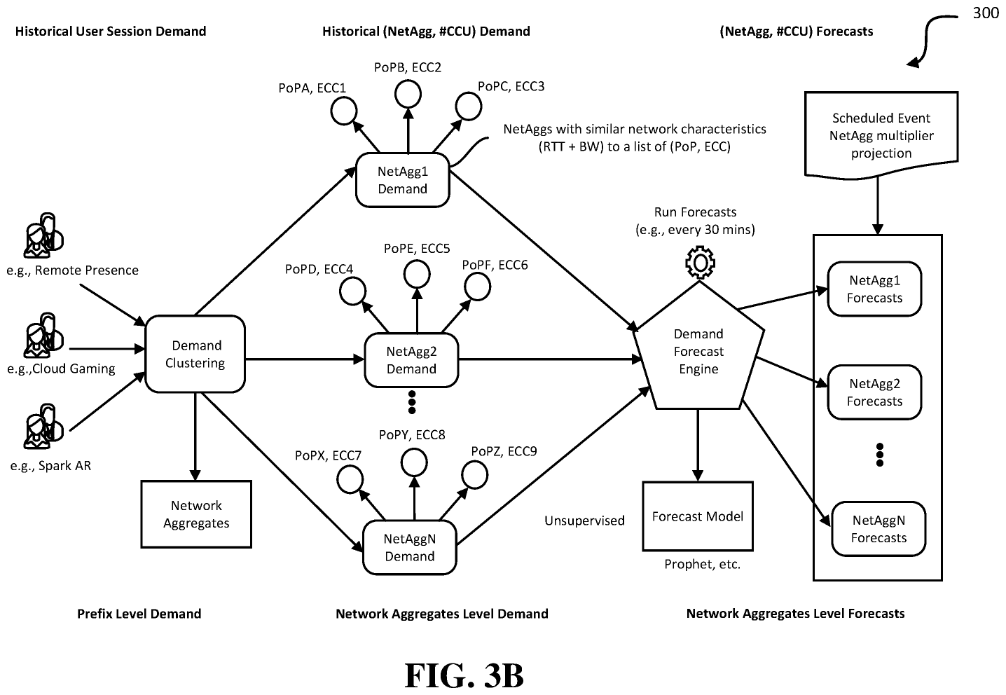

In some embodiments, as part of the demand clustering-based edge cloud workload placement operations, demand clustering-based edge cloud workload placement system 230 utilizes demand clustering to dynamically search for and select the demand-cluster-selected ECCs of ECCs 130. In some embodiments, the demand-cluster-selected ECCs are selected such that each satisfies edge cloud workload requirements managed by demand clustering-based edge cloud workload placement system 230. In some embodiments, demand clustering-based edge cloud workload placement system 230 generates, reserves, and allocates containers in the demand-cluster-selected ECCs of ECCs 130 to receive and place edge cloud workloads from, for example, computing devices 110. In some embodiments, the demand clustering-based edge cloud workload placement system utilizes demand clustering to efficiently schedule and place the edge cloud workloads onto the selected ECCs of ECCs 130. In some embodiments, when a user request (e.g., user request 371 of FIG. 3) arrives from computing devices 110, the user request is routed to the demand-cluster-selected ECC or demand-cluster-selected ECCs where the associated containers have been created, reserved, and allocated for placement of edge cloud workloads associated with the user request, thereby providing efficient and reliable service to end users of edge cloud network 100. Demand clustering-based edge cloud workload placement system 230 is described further in detail herein.

FIG. 2 illustrates an example processing system 200 of edge cloud network 100 in accordance with some embodiments. In some embodiments, processing system 200 may be, for example, an ECC server in ECCs 130 and/or an edge PoP server in edge PoPs 120, configured to perform one or more steps of one or more methods or operations described or illustrated herein. In some embodiments, one or more processing systems 200 may perform one or more steps of one or more methods or operations described or illustrated herein. In particular embodiments, one or more processing systems 200 provide functionality described or illustrated herein. In particular embodiments, software running on one or more processing systems 200 performs one or more steps of one or more methods described or illustrated herein or provides functionality described or illustrated herein. Particular embodiments include one or more portions of one or more processing systems 200. Herein, reference to a computer system may encompass a computing device, and vice versa, where appropriate. Moreover, reference to a computer system may encompass one or more computer systems, where appropriate.

This disclosure contemplates any suitable number of processing systems 200. This disclosure contemplates processing system 200 taking any suitable physical form. As example and not by way of limitation, processing system 200 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a server, a tablet computer system, or a combination of two or more of these. Where appropriate, processing system 200 may include one or more processing systems 200; be unitary or distributed; span multiple locations; span multiple machines; span multiple data centers; or reside in a cloud, which may include one or more cloud components in one or more networks. Where appropriate, one or more processing systems 200 may perform without substantial spatial or temporal limitation one or more steps of one or more methods described or illustrated herein. As an example and not by way of limitation, one or more processing systems 200 may perform in real time or in batch mode one or more steps of one or more methods described or illustrated herein. One or more processing systems 200 may perform at different times or at different locations one or more steps of one or more methods described or illustrated herein, where appropriate.

In some embodiments, processing system 200 includes a processor 202, memory 204, storage 206, an input/output (I/O) interface 208, a communication interface 210, and a bus 212. In some embodiments, the processing system described herein may be considered a computer system. Although this disclosure describes and illustrates a particular computer system having a particular number of particular components in a particular arrangement, this disclosure contemplates any suitable computer system having any suitable number of any suitable components in any suitable arrangement.

In some embodiments, processor 202 includes hardware for executing instructions, such as those making up a computer program. As an example and not by way of limitation, to execute instructions, processor 202 may retrieve (or fetch) the instructions from an internal register, an internal cache, memory 204, or storage 206; decode and execute them; and then write one or more results to an internal register, an internal cache, memory 204, or storage 206. In particular embodiments, processor 202 may include one or more internal caches for data, instructions, or addresses. This disclosure contemplates processor 202 including any suitable number of any suitable internal caches, where appropriate. As an example and not by way of limitation, processor 202 may include one or more instruction caches, one or more data caches, and one or more translation lookaside buffers (TLBs). Instructions in the instruction caches may be copies of instructions in memory 204 or storage 206, and the instruction caches may speed up retrieval of those instructions by processor 202. Data in the data caches may be copies of data in memory 204 or storage 206 for instructions executing at processor 202 to operate on; the results of previous instructions executed at processor 202 for access by subsequent instructions executing at processor 202 or for writing to memory 204 or storage 206; or other suitable data. The data caches may speed up read or write operations by processor 202. The TLBs may speed up virtual-address translation for processor 202. In particular embodiments, processor 202 may include one or more internal registers for data, instructions, or addresses. This disclosure contemplates processor 202 including any suitable number of any suitable internal registers, where appropriate. Where appropriate, processor 202 may include one or more arithmetic logic units (ALUs); be a multi-core processor; or include one or more processors 202. Although this disclosure describes and illustrates a particular processor, this disclosure contemplates any suitable processor.

In some embodiments, memory 204 includes main memory for storing instructions for processor 202 to execute or data for processor 202 to operate on. As an example and not by way of limitation, processing system 200 may load instructions from storage 206 or another source (such as, for example, another processing system 200) to memory 204. Processor 202 may then load the instructions from memory 204 to an internal register or internal cache. To execute the instructions, processor 202 may retrieve the instructions from the internal register or internal cache and decode them. During or after execution of the instructions, processor 202 may write one or more results (which may be intermediate or final results) to the internal register or internal cache. Processor 202 may then write one or more of those results to memory 204. In particular embodiments, processor 202 executes only instructions in one or more internal registers or internal caches or in memory 204 (as opposed to storage 206 or elsewhere) and operates only on data in one or more internal registers or internal caches or in memory 204 (as opposed to storage 206 or elsewhere). One or more memory buses (which may each include an address bus and a data bus) may couple processor 202 to memory 204. Bus 212 may include one or more memory buses. In particular embodiments, one or more memory management units (MMUs) reside between processor 202 and memory 204 and facilitate accesses to memory 204 requested by processor 202. In particular embodiments, memory 204 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 204 may include one or more memories 204, where appropriate. Although this disclosure describes and illustrates particular memory, this disclosure contemplates any suitable memory. In some embodiments, memory 204 includes a demand clustering-based edge cloud workload placement system 230, described further herein.

In some embodiments, storage 206 includes mass storage for data or instructions. As an example and not by way of limitation, storage 206 may include a hard disk drive (HDD), a floppy disk drive, flash memory, an optical disc, a magneto-optical disc, magnetic tape, or a Universal Serial Bus (USB) drive or a combination of two or more of these. Storage 206 may include removable or non-removable (or fixed) media, where appropriate. Storage 206 may be internal or external to processing system 200, where appropriate. In particular embodiments, storage 206 is non-volatile, solid-state memory. In particular embodiments, storage 206 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 206 taking any suitable physical form. Storage 206 may include one or more storage control units facilitating communication between processor 202 and storage 206, where appropriate. Where appropriate, storage 206 may include one or more storages 206. Although this disclosure describes and illustrates particular storage, this disclosure contemplates any suitable storage.

In some embodiments, I/O interface 208 includes hardware, software, or both, providing one or more interfaces for communication between processing system 200 and one or more I/O devices. Processing system 200 may include one or more of these I/O devices, where appropriate. One or more of these I/O devices may enable communication between a person and processing system 200. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. In some embodiments, I/O devices may include a camera configured to digitally capture images. This disclosure contemplates any suitable I/O devices and any suitable I/O interfaces 208 for them. Where appropriate, I/O interface 208 may include one or more device or software drivers enabling processor 202 to drive one or more of these I/O devices. I/O interface 208 may include one or more I/O interfaces 208, where appropriate. Although this disclosure describes and illustrates a particular I/O interface, this disclosure contemplates any suitable I/O interface.

As an example and not by way of limitation, processing system 200 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, processing system 200 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these.

In some embodiments, bus 212 includes hardware, software, or both coupling components of processing system 200 to each other. As an example and not by way of limitation, bus 212 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 212 may include one or more buses 212, where appropriate. Although this disclosure describes and illustrates a particular bus, this disclosure contemplates any suitable bus or interconnect.

As described herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, secure digital cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

As an example and not by way of limitation, communication interface 210 may include a network interface controller (NIC) or network adapter for communicating with an Ethernet or other wire-based network or a wireless NIC (WNIC) or wireless adapter for communicating with a wireless network. Processing system 200 may include any suitable communication interface 210 configured to perform some of the embodiments described herein for any of these networks, where appropriate. Communication interface 210 may include one or more communication interfaces, where appropriate. In some embodiments, communication interface 210 includes hardware, software, or both providing one or more interfaces for communication (such as, for example, packet-based communication) between processing system 200 and processing system 200, and one or more other processing systems or one or more networks.

FIG. 3A illustrates demand clustering-based edge cloud workload placement system 230 of FIG. 2 in accordance with some embodiments. In some embodiments, demand clustering-based edge cloud workload placement system 230 includes a workload profile unit 320, a demand forecasting and clustering unit 390, a workload placement engine 310, a capacity reservation system 360, and a real-time end-to-end (E2E) targeting system 370. In some embodiments, demand clustering-based edge cloud workload placement system 230 is executable code configured to utilize demand clustering of internet protocol (IP) prefixes associated with user session requests to perform edge cloud workload placement and demand forecasting on demand-cluster-selected ECCs of ECCs 130. In some embodiments, demand-cluster-selected ECCs are a top X number of ECCs that are selected based upon a minimum E2E RTT assessment of E2E RTTs associated with the IP prefixes, where X is a natural number greater than 1, such as, for example, 2, 3, 4, etc.

In some embodiments, the IP prefixes are aggregated by demand forecasting and clustering unit 390 based on a similarity of IP prefix network characteristics 393. In some embodiments, the demand clustering of IP prefixes is utilized to generate edge cloud workload demand forecasts 341 for placement of edge cloud workloads in demand-cluster-selected ECCs of ECCs 130. In some embodiments, an IP prefix network characteristic of IP prefix network characteristics 393 is a network characteristic of an IP prefix that is associated with a user session request received from a client device of computing devices 110. In some embodiments, in utilizing the demand-cluster-selected ECCs of ECCs 130, user requests 371 received from computing devices 110 and/or workload requests 372 received from computing devices 110 may be routed to the demand-cluster-selected ECCs of ECCs 130 selected utilizing the demand forecasting and clustering unit 390 and workload placement engine 310 of demand clustering-based edge cloud workload placement system 230.

In some embodiments, demand forecasting and clustering unit 390 is executable code configured to utilize demand clustering (by demand clustering unit 330) of IP prefixes associated with user session requests that are aggregated based on similar IP prefix network characteristics 393 to generate edge cloud workload demand forecasts 341. In some embodiments, an edge cloud workload demand forecast is a demand forecast generated by demand forecasting unit 340 of demand forecasting and clustering unit 390 that is utilized by the workload placement engine 310 for edge cloud workload placement in edge cloud network 100. In some embodiments, edge cloud workload demand forecasts 341 are a plurality of edge cloud workload demand forecasts, wherein each edge cloud workload demand forecast is a forecasted demand for each demand NetAgg of demand NetAggs 331. In some embodiments, a demand NetAgg is an aggregation of IP prefixes associated with user session requests received from computing devices 110 into groups (e.g., NetAggs) based upon network characteristics associated with the IP prefixes. For example, in some embodiments, the IP prefixes are aggregated by demand clustering unit 330 based on similar IP prefix network characteristics. In some embodiments, demand NetAggs 331 are a list of demand NetAggs generated by demand clustering unit 330. In some embodiments, the edge cloud workload demand forecasts 341 are provided to workload placement engine 310 for edge cloud workload placement on the demand-cluster-selected ECCs of ECCs 130 of edge cloud network 100.

In some embodiments, demand forecasting and clustering unit 390 generates the edge cloud workload demand forecasts 341 by utilizing a NetAgg-based demand clustering parameter of NetAgg-based demand clustering parameters 391. In some embodiments, NetAgg-based demand clustering parameters 391 are demand clustering parameters that may be utilized by demand forecasting and clustering unit 390 to generate demand NetAggs 331 and edge cloud workload demand forecasts 341. In some embodiments, NetAgg-based demand clustering parameters 391 include, in addition to IP prefix network characteristics 393, a predicted IP prefix level demand 392 and a projected demand correction factor 394. In some embodiments, an IP prefix level demand is the number of concurrent user sessions associated with an IP prefix. In some embodiments, predicted IP prefix level demand 392 is a predicted IP prefix level demand. For example, in some embodiments, predicted IP prefix level demand 392 may be provided as input to the demand forecasting and clustering unit 390.

In some embodiments, projected demand correction factor 394 is a projected demand correction factor utilized by demand forecasting and clustering unit 390 to account for demand spikes in edge cloud network 100. In some embodiments, a demand spike is a sudden and significant increase in user requests, traffic, or resource utilization in edge cloud network 100 within a short period of time. Demand spikes may occur due to various factors and are often characterized by a rapid surge in the volume of requests or data flowing into edge cloud network 100. In some embodiments, a demand spike may be an anticipated demand spike (e.g., a demand spike caused by a scheduled event) or an unanticipated demand spike (e.g., a demand spike caused by an unscheduled event). In some embodiments, a scheduled event may be, for example, a virtual reality (VR) concert, National Basketball Association (NBA) game, etc., that is known to demand clustering-based edge cloud workload placement system 230 in advance. In some embodiments, an unscheduled event may be, for example, a new software application that unexpectedly causes demand to increase in edge cloud network 100 that is not known to demand clustering-based edge cloud workload placement system 230 in advance.

In some embodiments, demand forecasting unit 340 of demand forecasting and clustering unit 390 may account for demand spikes (e.g., anticipated demand spikes and the unanticipated demand spikes) by adding projected demand correction factor 394 to demand forecasts (e.g., NetAgg1 Forecasts, NetAgg2 Forecasts, . . . NetAggN Forecasts) prior to generating the edge cloud workload demand forecasts 341 or multiplying projected demand correction factor 394 as a scheduled event NetAgg multiplier projection of demand forecasts prior to generating the edge cloud workload demand forecasts 341. For example, in some embodiments, projected demand correction factor 394 may be added to demand forecasts at demand forecasting unit 340 to generate edge cloud workload demand forecasts 341 when a VR concert or NBA game occurs that causes, for example, a CCU spike of 10× or more. In some embodiments, for smaller scale events, demand forecasting and clustering unit 390 may add a fixed buffer to memory 204 to account for the smaller scale events in generating the edge cloud workload demand forecasts 341. In some embodiments, for a large-scale scheduled event (e.g., a large-scale nationwide popular scheduled event), demand forecasting and clustering unit 390 may, based on historically similar events, project, for example, a user population increase during the event in NetAggs or demand NetAggs, leveraging geoinformation to generate edge cloud workload demand forecasts 341. In some embodiments, to ensure a sufficient edge workload placement during a demand spike (e.g., for peak events or smaller scale events), demand forecasting and clustering unit 390 may add a fixed buffer to memory 204 for the forecasted demands to generate the edge cloud workload demand forecasts 341.

In some embodiments, demand forecasting and clustering unit 390 includes a demand clustering unit 330, a demand forecasting unit 340, and optionally an event demand prediction unit 350. In some embodiments, demand clustering unit 330 is executable code configured to generate demand NetAggs 331 for use by demand forecasting unit 340 to generate edge cloud workload demand forecasts 341 for placement of edge cloud workloads in demand-cluster-selected ECCs of ECCs 130 by workload placement engine 310. In some embodiments, as stated previously, a demand NetAgg is an aggregation of IP prefixes associated with user session requests received from computing devices 110 into groups (e.g., NetAggs) based upon network characteristics associated with the IP prefixes (e.g., similar IP prefix network characteristics 393 associated with each IP prefix of a list of IP prefixes 301).

In some embodiments, demand clustering unit 330 may perform a similar-IP-prefix-network-characteristics assessment 411 (e.g., utilize a similarity function) that utilizes an E2E RTT IP prefix network characteristic to aggregate IP prefixes into a demand NetAgg. In some embodiments, IP prefixes have similar IP prefix network characteristics when demand clustering unit 330 determines that the IP prefixes have the same top two distinct ECCs of ECCs 130 with the shortest E2E RTTs and a difference of the E2E RTT values between the IP prefixes to the same ECC is less than a similarity score threshold. In some embodiments, the similarity score threshold is a threshold value related to an IP prefix network characteristic that indicates that IP prefixes associated with the IP prefix network characteristic are similar. In some embodiments, the similarity score threshold may be, for example, a time selected by demand clustering-based edge cloud workload placement system 230 to indicate that IP prefix network characteristics are similar. In some embodiments, with reference to the similar-IP-prefix-network-characteristics assessment 411, the similarity score threshold may be, for example, twenty milliseconds, thirty milliseconds, or some other configurable similarity score threshold.

In some embodiments, when demand clustering unit 330 determines that IP prefix network characteristics associated with IP prefixes satisfy the similar-IP-prefix-network-characteristics assessment 411, the IP prefixes have similar IP prefix network characteristics for placement of edge cloud workloads by workload placement engine 310 and may be aggregated into the same demand NetAgg of demand NetAggs 331. For example, in some embodiments, when demand clustering unit 330 determines that the two IP prefixes have the same top two distinct ECCs with the shortest E2E RTTs and a difference of the E2E RTT values between the two IP prefixes to the same ECC is less than twenty milliseconds, the two IP prefixes have similar IP prefix network characteristics and are aggregated into a demand NetAgg of demand NetAggs 331 and may be utilized for edge cloud workload placement by workload placement engine 310. Thus, in some embodiments, when, as a result of the similar-IP-prefix-network-characteristics assessment 411, the demand clustering unit 330 determines that IP prefix network characteristics associated with user session requests received from computing devices 110 are similar according to the similarity function, the IP prefixes associated with the similar IP network characteristics are aggregated to form a demand NetAgg of demand NetAggs 331. Demand clustering unit 330 is described further herein.

In some embodiments, demand forecasting unit 340 is executable code configured to generate edge cloud workload demand forecasts 341. In some embodiments, an edge cloud workload demand forecast (of edge cloud workload demand forecasts 341 generated by demand forecasting unit 340) is a NetAgg level demand forecast that is provided to workload placement engine 310 to optimize edge cloud workload placement decision making for placement of edge cloud workloads on demand-cluster-selected ECCs of ECCs 130 by workload placement engine 310.

In some embodiments, the demand forecasting unit 340 generates the edge cloud workload demand forecasts 341 by utilizing demand forecasting algorithms that are based on historical network aggregate level demands on a NetAggs level using an aggregated number of concurrent user sessions (CCUs) in the groups generated by demand clustering unit 330 and generating forecasted demands in each NetAgg. In some embodiments, for N number of network aggregate level forecasts, the NetAggs level forecasts may be represented as, for example, a NetAgg1 Forecast, a NetAgg2 Forecast, . . . a NetAggN Forecast. In some embodiments, demand forecasting unit 340 of demand forecasting and clustering unit 390 provides or passes down edge cloud workload demand forecasts 341 (e.g., NetAgg Forecasts (i.e., NetAgg level demand forecasts)) to workload placement engine 310 for optimized workload placement decision making and placement of edge cloud workloads in demand-cluster-selected ECCs of ECCs 130.

FIG. 3B illustrates an end-to-end (E2E) architecture 300 in accordance with some embodiments. In some embodiments, FIG. 3B illustrates the E2E architecture 300 of the demand forecasting and demand clustering executed utilizing demand forecasting and clustering unit 390 of FIG. 3A. In FIG. 3B, the demand clustering and demand clustering performed by demand forecasting and clustering unit 390 groups IP prefix level demand into demand NetAggs 331, exemplifying a prefix level demand, network aggregates level demand, and network aggregates level forecasts that are utilized for edge cloud workload placement by demand clustering-based edge cloud workload placement system 230 as described herein.

With further reference to FIG. 3A, in some embodiments, event demand prediction unit 350 is executable code configured to predict event demands for demand forecasting and clustering unit 390. In some embodiments, event demand prediction unit 350 receives, for example, scheduled events from demand clustering-based edge cloud workload placement system 230, and forecasts the expected volume to be generated by computing devices 110, applications utilized on computing devices 110, or users of edge cloud network 100. In some embodiments, the events may include data requests, service requests, sensor readings, user interactions, or any other type of activity that requires processing or resources at the edge of the network.

In some embodiments, workload profile unit 320 is executable code configured to generate a workload profile 321 of edge cloud workloads for use by workload placement engine 310 in edge cloud workload placement of edge cloud workloads in edge cloud network 100. In some embodiments, workload profile 321 is a workload profile that includes a compute capacity and a network service level objective (SLO) that may be utilized for each edge compute workload. In some embodiments, as a result of the workload profiling, workload profile unit 320 generates, for example, workload compute resource requirements, workload network requirements, and/or workload container configurations for use by workload placement engine 310. In some embodiments, workload profile unit 320 generates workload profile 321 by utilizing pre-defined configurations or via periodic service benchmarking and continuous monitoring of resource usage. In some embodiments, inputs to the workload profile unit 320 may be, for example, an application performance benchmark, workload run-time characteristics from performance in production, and/or data from existing SLO computing pipelines for various edge cloud network applications. In some embodiments, workload profile unit 320 provides the workload profile 321 to workload placement engine 310 for edge cloud workload placement.

In some embodiments, workload placement engine 310 is executable code configured to generate, in addition to a capacity reservation decision 314 and a per-workload-type capacity intent 313, a per-workload-type-NetAgg demand map 317 that is provided to real-time E2E targeting system 370 for edge cloud workload placement on edge cloud network 100. In some embodiments, the per-workload-type-NetAgg demand map 317 includes directives to demand-cluster-selected ECCs of ECCs 130 that are utilized by capacity reservation system 360 for capacity reservations for a given user request 371 or workload request 372 from computing devices 110 for edge cloud workload placement. In some embodiments, the workload placement engine 310 utilizes the online workload optimization unit 311 to determine which demand-cluster-selected ECCs of ECCs 130 to reserve capacity for a given user request 371 or workload request 372 from computing devices 110 by generating, in addition to the capacity reservation decision 314, the per-workload-type-NetAgg demand map 317 and the per-workload-type capacity intent 313 for use in placement of edge cloud workloads in demand-cluster-selected ECCs of ECCs 130. In some embodiments, the per-workload-type capacity intent 313, capacity reservation decision 314, and per-workload-type-NetAgg demand map 317 generated by workload placement engine 310 are described further in detail herein.

In some embodiments, workload placement engine 310 includes an online workload optimization unit 311 and an offline evaluation unit 312. In some embodiments, the online workload optimization unit 311 is executable code configured to generate the per-workload-type capacity intent 313 and capacity reservation decision 314 that are provided to capacity reservation system 360 and the per-workload-type-NetAgg demand map 317 that is provided to real-time E2E targeting system 370. In some embodiments, the per-workload-type-NetAgg demand map 317 is a map of per workload type/NetAgg demands utilized by real-time E2E targeting system 370 to route a user request 371 or a workload request 372 to the demand-cluster-selected ECCs of ECCs 130. In some embodiments, the per-workload-type-NetAgg demand map 317 may be, for example, a many-to-many map of per workload type/NetAgg demand that supports fractional mapping (e.g., from NetAgg to a workload/ECC tuple). In some embodiments, fractional mapping is a mapping that may be utilized by online workload optimization unit 311 when a workload demand may be assigned to multiple demand-cluster-selected ECCs of ECCs 130. In some embodiments, when, for example, fractional mapping occurs, fractional numbers for each demand-cluster-selected ECC of ECCs 130 may be attached as output to the workload placement engine 310 that is provided to real-time E2E targeting system 370.

In some embodiments, per-workload-type capacity intent 313 is a capacity intent generated by online workload optimization unit 311 for each edge cloud workload that is placed at the demand-cluster-selected ECCs of ECCs 130. In some embodiments, the per-workload-type capacity intent 313 includes a description of a number of machines of a certain SKU type mapped to a regional location that is required for each workload that is placed at the demand-cluster-selected ECCs of ECCs 130 (e.g., for a specific workload type, workload placement engine 310 requires X machines of SKU type Y at region Z, where X is the number of machines, Y is the SKU type, Z is the region). In some embodiments, utilization of the per-workload-type capacity intent 313 enables the workload placement engine 310 to scale up to, for example, millions of servers in ECCs 130 serving millions of user requests and/or workload requests from computing devices 110.

In some embodiments, online workload optimization unit 311 generates the per-workload-type-NetAgg demand map 317 and the per-workload-type capacity intent 313 by utilizing a demand-NetAgg-based linear programming optimization model. In some embodiments, the demand-NetAgg-based linear programming optimization model is a linear programming optimization model that receives, as input, edge cloud workload demand forecasts 341 from the demand forecasting and clustering unit 390, a workload profile 321 from the workload profile unit 320, a capacity supply 381 from workload placement parameters unit 380, a maintenance schedule 382 from workload placement parameters unit 380, an edge topology 383 from workload placement parameters unit 380, and an RTT measurement 384 from workload placement parameters unit 380 and generates the per-workload-type-NetAgg demand map 317 for real-time E2E targeting system 370 and per-workload-type capacity intent 313 for capacity reservation system 360. For example, online workload optimization unit 311 utilizes demand-NetAgg-based linear programming optimization model to optimize selection decisions on which demand-cluster-selected ECCs of ECCs 130 to generate per-workload-type-NetAgg demand map 317 and the per-workload-type capacity intent 313. In some embodiments, the per-workload-type-NetAgg demand map 317 is provided as workload placement results to real-time E2E targeting system 370, whereas the per-workload-type capacity intent 313 is provided to capacity reservation system 360.

In some embodiments, in addition to the workload placement parameters provided in workload placement parameters unit 380, online workload optimization unit 311 of workload placement engine 310 may also utilize latency data received as input from the workload profile unit 320 and/or a workload setting 318 received from offline evaluation unit 312 to compute the per-workload-type-NetAgg demand map 317 and per-workload-type capacity intent 313. In some embodiments, as stated previously, the per-workload-type-NetAgg demand map 317 is a map of per workload type/NetAgg demands utilized by real-time E2E targeting system 370 to route a user request 371 or a workload request 372 to the demand-cluster-selected ECCs of ECCs 130 that have been optimally selected utilizing the demand forecasting and clustering unit 390 and workload placement engine 310.

In some embodiments, in addition to including online workload optimization unit 311, workload placement engine 310 includes offline evaluation unit 312. In some embodiments, offline evaluation unit 312 is executable code configured to evaluate the workload placement results (e.g., per-workload-type capacity intent 313, capacity reservation decision 314, and/or per-workload-type-NetAgg demand map 317) generated by online workload optimization unit 311 for edge cloud workload placement performance balance. In some embodiments, offline evaluation unit 312 may be configured to, for example, recommend a workload setting 318 for the online workload optimization unit 311 to provide a workload balance between performance, efficiency and reliability of the edge cloud workload placement provided by demand clustering-based edge cloud workload placement system 230. In some embodiments, workload setting 318 may be a configurable workload setting configured to change at a minimal pace, such as, for example, a weekly or biweekly pace, to provide the edge cloud workload placement performance balance.

In some embodiments, the workload placement results may be evaluated by offline evaluation unit 312 based on evaluation criteria, such as, efficiency, reliability/disaster recovery (DR), and/or performance/SLO. In some embodiments, based on the evaluation of the workload placement results by offline evaluation unit 312 under various scenarios (e.g., DR, non-DR, requests spike), an edge cloud workload placement trade-off may be made by online workload optimization unit 311 based on multiple tunable system parameters and options. In some embodiments, the multiple tunable system parameters and options may include, for example, a frequency of edge cloud workload placement, a headroom for left-over capacity, a maximum acceptable churn across consecutive solutions (e.g., a solution may be too disruptive and expensive to switch workloads due to, for example, “cold start” issues). In some embodiments, utilizing the results of the offline evaluation unit 312, online workload optimization unit 311 may minimize a total number of context switches, redundant operations, and reliability parameters for edge cloud workload placement. Furthermore, as a result of the evaluation performed by offline evaluation unit 312, additional available capacity in demand-cluster-selected ECCs of ECCs 130 may be shared by eligible edge cloud workloads.

In some embodiments, offline evaluation unit 312 may be configured to ensure correct

settings of an online optimizer that may be configured to feed into capacity reservation system 360, which may include, for example, an Infrastructure as a Service (IaaS) capacity management system. In some embodiments, the online optimizer may prescribe and enforce per workload minimum headroom based on, for example, a worst-case overflow assumption utilized by the offline evaluation unit 312. In some embodiments, a default or fallback choice may be utilized by online workload optimization unit 311 when assigning a user request 371 or workload request 372 to a demand-cluster-selected ECC of ECCs 130, which may be reserved by capacity reservation system 360 for a short period of time before user request 371 or workload request 372 is served utilizing a primary choice. In some embodiments, the workload setting 318 is provided to online workload optimization unit 311 for edge cloud workload placement optimization.

In some embodiments, in addition to the per-workload-type capacity intent 313 provided to capacity reservation system 360, a capacity reservation decision 314 is also generated by workload placement engine 310 and provided to capacity reservation system 360. In some embodiments, a capacity reservation decision 314 is a reservation decision made by workload placement engine 310 that indicates which demand-cluster-selected ECC of ECCs 130 to reserve the capacity for a given user request 371 or workload request 372 from computing devices 110. In some embodiments, capacity reservation decision 314 generated by online workload optimization unit 311 is provided to capacity reservation system 360.

In some embodiments, capacity reservation system 360 is executable code configured to provision capacity for the placement of edge cloud workloads on demand-cluster-selected ECCs of ECCs 130 selected utilizing the demand forecasting and clustering unit 390 and workload placement engine 310. In some embodiments, capacity reservation system 360 provisions the capacity for the placement of edge cloud workloads utilizing capacity intent (e.g., per-workload-type capacity intent 313) and reservation decisions (e.g., capacity reservation decision 314) received from workload placement engine 310. In some embodiments, capacity reservation system 360 materializes the capacity intents to a list of ECC servers of the demand-cluster-selected ECCs of ECCs 130 with correct host configuration and reserves the list of ECC servers of the demand-cluster-selected ECCs of ECCs 130 required for service according to the reservation decisions provided by workload placement engine 310. In some embodiments, the capacity reservation system 360 is configured to receive capacity intent and reservation decisions as input from workload placement engine 310 and generate, based on the capacity intent and reservation decisions, live capacity utilization data 361 as output to real-time E2E targeting system 370. In some embodiments, live capacity utilization data may refer to real-time or near-real-time information about the current usage of computing resources (such as CPU, memory, storage, and network bandwidth) across demand-cluster-selected ECCs of ECCs 130 of the edge cloud network 100.

In some embodiments, real-time E2E targeting system 370 is executable code configured to route a user request or a workload request to the demand-cluster-selected ECCs of ECCs 130 that have been optimally selected utilizing the demand forecasting and clustering unit 390 and workload placement engine 310. In some embodiments, the output of real-time E2E targeting system 370 may be, for example, routing decisions 373 for use by demand clustering-based edge cloud workload placement system 230. In some embodiments, the optimally selected demand-cluster-selected ECCs of ECCs 130 include a container or containers that have been created, reserved, and allocated by demand clustering-based edge cloud workload placement system 230 utilizing the demand forecasting and clustering unit 390, capacity reservation system 360, and workload placement engine 310. In some embodiments, real-time E2E target system 370 is configured to receive the workload placement information (e.g., per-workload-type-NetAgg demand map 317) from workload placement engine 310, live capacity utilization data 361 from capacity reservation system 360, and incoming user requests from users of computing devices 110 or workload requests from the computing devices 110, and generate routing decisions 373 that are utilized to route the user requests (e.g., user request 371) and/or workload requests (e.g., workload request 372) to the demand-cluster-selected ECCs of ECCs 130 selected utilizing the demand forecasting and clustering unit 390 and workload placement engine 310. For example, in some embodiments, when a user request 371 associated with a user of a computing device of computing devices 110 or a workload request 372 is received from a computing device of computing devices 110 and arrives at the real-time E2E target system, the real-time E2E targeting system 370 routes the user request 371 or workload request 372 to the optimally selected demand-cluster-selected ECCs of ECCs 130 where a container or containers have been created, reserved, and allocated for the user request 371 or workload request 372.

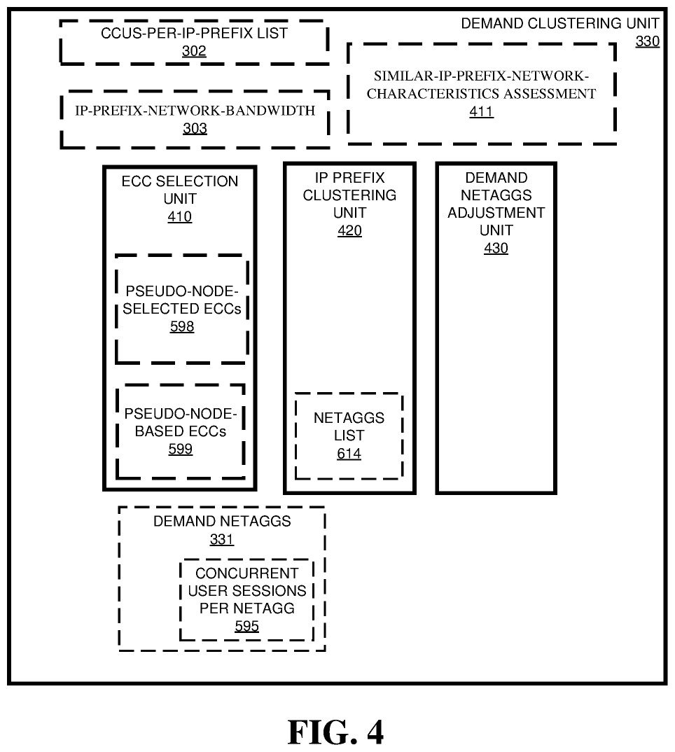

FIG. 4 illustrates demand clustering unit 330 of FIG. 3A in accordance with some embodiments. In some embodiments, as stated previously, demand clustering unit 330 is executable code configured to generate demand NetAggs 331 for use by demand forecasting unit 340 to generate edge cloud workload demand forecasts 341 for placement of edge cloud workloads in demand-cluster-selected ECCs of ECCs 130. In some embodiments, the demand clustering unit 330 is configured to utilize an ECC selection unit 410, an IP prefix clustering unit 420, and optionally a demand NetAggs adjustment unit 430 to generate demand NetAggs 331. In some embodiments, the demand clustering unit 330 utilizes a similar-IP-prefix-network-characteristics assessment 411 of IP prefix network characteristics 393 of IP prefixes associated with user session requests received from computing devices 110 to generate demand NetAggs 331. The operations of demand clustering unit 330 are described further herein.

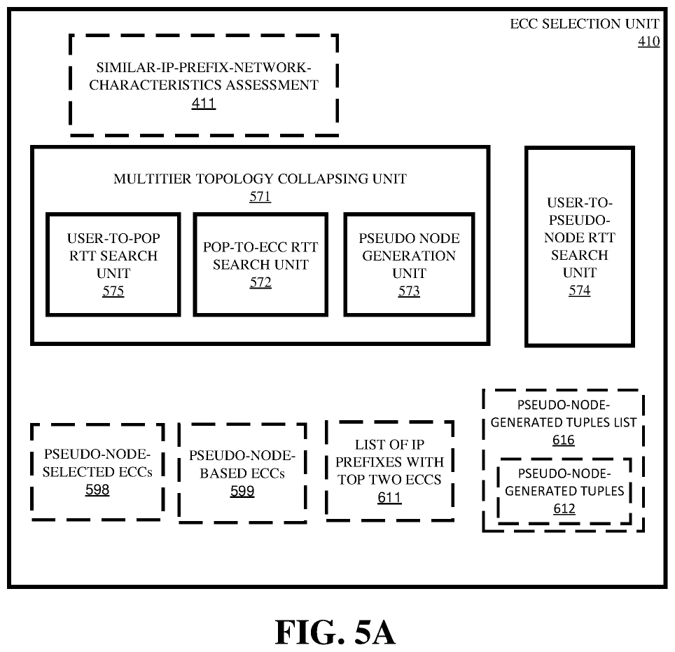

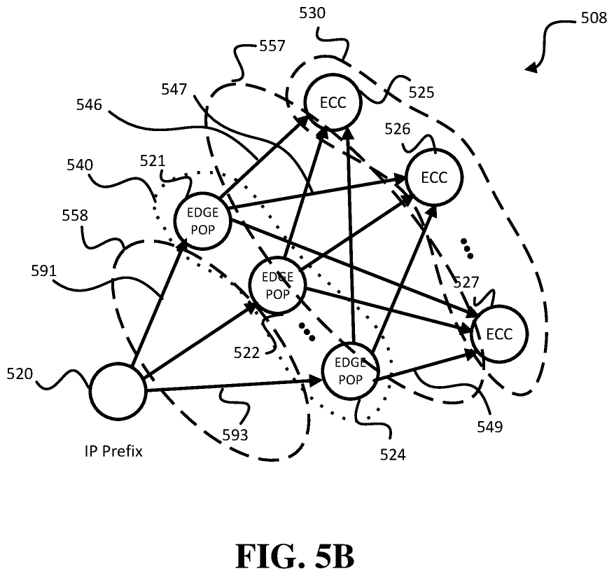

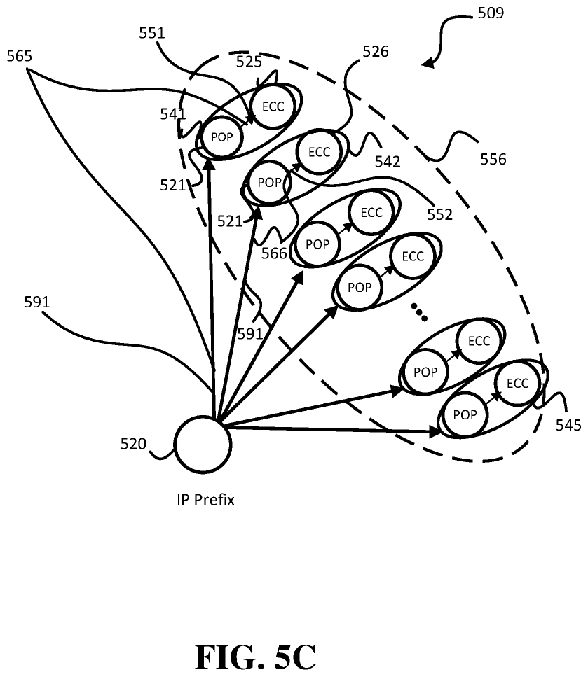

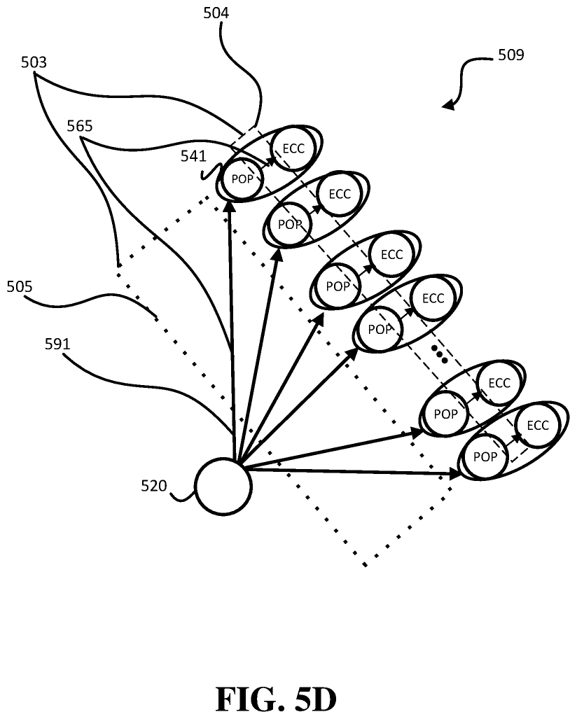

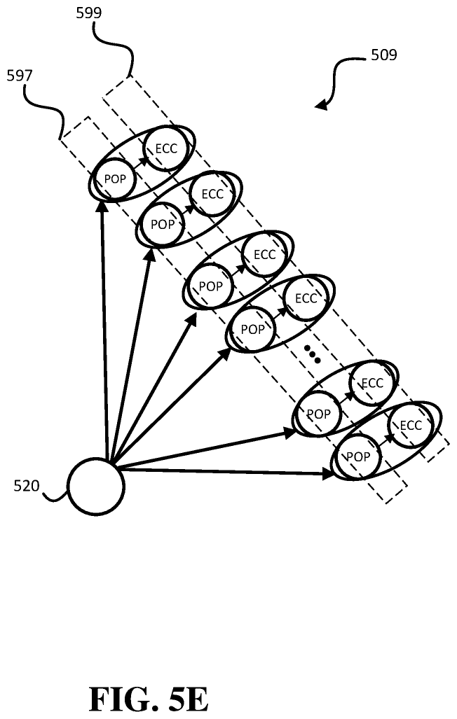

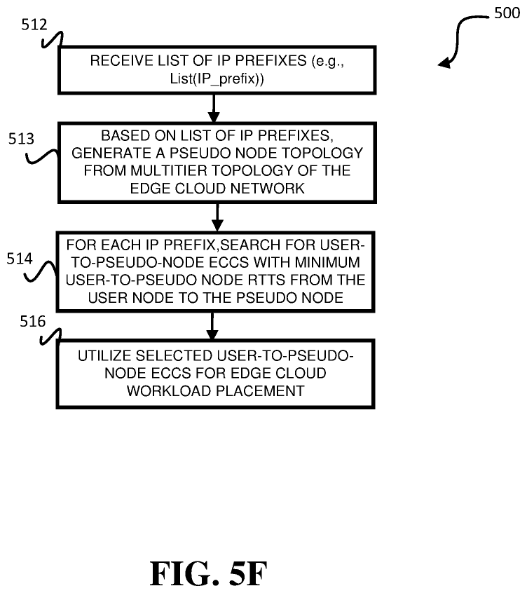

FIG. 5A illustrates the ECC selection unit 410 of FIG. 4 in accordance with some embodiments. In some embodiments, the ECC selection unit 410 includes a multitier topology collapsing unit 571 and a user-to-pseudo-node RTT search unit 574. In some embodiments, the ECC selection unit 410 is executable code configured to utilize the multitier topology collapsing unit 571 and the user-to-pseudo-node RTT search unit 574 to ascertain pseudo-node-selected ECCs 598 (e.g., demand-cluster-selected ECCs of ECCs 130) from pseudo-node-based ECCs 599 of a pseudo node topology 509 of edge cloud network 100. In some embodiments, the pseudo node topology 509 is a topological representation of a transformation of a multitier topology 508 of edge cloud network 100 generated by multitier topology collapsing unit 571. In some embodiments, the multitier topology 508 is a multitier topological representation of edge cloud network 100, that includes, for example, a user node (e.g., user node 520), PoP nodes 540 (e.g., PoP node 521, PoP node 522, -PoP node 524), and ECC nodes 530 (e.g., ECC node 525-ECC node 527) of the edge cloud network 100, as illustrated by way of example in FIG. 5B. In some embodiments, pseudo-node-selected ECCs 598 are demand-cluster-selected ECCs of ECCs 130 selected from pseudo-node-based ECCs 599 generated by ECC selection unit 410 based upon the similar-IP-prefix-network-characteristics assessment 411 of the IP prefix network characteristics 393.

Recall that IP prefixes have similar IP prefix network characteristics when demand clustering unit 330 (in this case, for example, ECC selection unit 410 of demand clustering unit 330) determines that the IP prefixes have the same top two distinct ECCs of ECCs 130 with minimum (e.g., shortest) E2E RTTs and a difference of the E2E RTT values between the IP prefixes to the same ECC is less than a similarity score threshold. In some embodiments, in order to determine the minimum (e.g., shortest) E2E RTTs of the IP prefixes, ECC selection unit 410 performs a minimum size RTT assessment of user-to-pseudo-node RTTs 503 of the pseudo node topology 509 of the edge cloud network 100, illustrated in FIG. 5D. In some embodiments, ECC selection unit 410 may utilize, for example, a demand-clustering-based modified Bellman-Ford algorithm to find the minimum E2E RTTs (e.g., the shortest paths between the user nodes and the ECCs 130), where the demand-clustering-based modified Bellman-Ford algorithm is utilized to find the top X number of ECCs with the shortest or minimum E2E RTTs, where X is a natural number greater than 1, such as, for example, 2, 3, 4, etc., dependent on system design. In some embodiments, the pseudo-node-selected ECCs 598 ascertained using the pseudo node topology 509 are utilized to route user requests (e.g., user request 371) and/or workload requests (e.g., workload request 372) through the edge cloud network 100 from a computing device of computing devices 110.

### Generating a Pseudo Node Topology from a Multitier Topology

In some embodiments, in order to ascertain the pseudo-node-selected ECCs 598 (e.g., demand-cluster-selected ECCs), ECC selection unit 410 utilizes multitier topology collapsing unit 571 to generate pseudo node topology 509 from multitier topology 508. In some embodiments, the multitier topology collapsing unit 571 is executable code configured to collapse the multitier topology 508 of the edge cloud network 100 into a pseudo node topology 509 of the edge cloud network 100 for use in generating demand NetAggs 331.

In some embodiments, the multitier topology collapsing unit 571 includes a PoP-to-ECC RTT search unit 572, a user-to-PoP RTT search unit 575, and a pseudo node generation unit 573. In some embodiments, PoP-to-ECC RTT search unit 572 is executable code configured to perform a PoP-to-ECC RTT assessment of the PoP-to-ECC RTTs 557 (e.g., PoP-to-ECC RTT 546-PoP-to-ECC RTT 549) represented in the multitier topology 508. In some embodiments, a PoP-to-ECC RTT is an RTT from a PoP node in PoP nodes 540 (e.g., PoP node 521-PoP node 524) to an associated ECC in ECC nodes 530 (e.g., ECC node 525-ECC node 527) of the multitier topology 508 of the edge cloud network 100, as illustrated by way of example in FIG. 5B. In some embodiments, the PoP-to-ECC RTT assessment is a round trip time assessment of the RTTs from PoP nodes 540 to ECC nodes 530 of the multitier topology 508 that is configured to ascertain an N number (in this example, N=2) of RTTs having minimum PoP-to-ECC RTT values (e.g., a first minimum PoP-to-ECC RTT and a second minimum PoP-to-ECC RTT). In some embodiments, the RTTs from user node 520 to PoP nodes 540 are user-to-PoP RTTs 558, which includes user-to-PoP RTT 591-user-to-PoP RTT 593. In some embodiments, a user-to-PoP RTT is an RTT between a user node (e.g., user node 520) and PoP nodes 540 (e.g., PoP node 521-PoP node 524) of the multitier topology 508 of the edge cloud network 100, as illustrated by way of example in FIG. 5B. In some embodiments, user-to-PoP RTT search unit 575 is executable code configured to perform a user-to-PoP RTT assessment of the user-to-PoP RTTs 558 (e.g., user-to-PoP RTT 591-user-to-PoP RTT 593) represented in the multitier topology 508.

In some embodiments, the PoP-to-ECC RTT search unit 572 performs the PoP-to-ECC RTT assessment by, for each PoP node of PoP nodes 540 of the multitier topology 508, searching the multitier topology 508 for a first PoP-to-ECC RTT ECC that maps to a first minimum PoP-to-ECC RTT of the PoP-to-ECC RTTs associated with a PoP node and a second PoP-to-ECC RTT ECC that maps to a second minimum PoP-to-ECC RTT of the PoP-to-ECC RTTs associated with a PoP node of the PoP nodes 540. In some embodiments, the first minimum PoP-to-ECC RTT is the PoP-to-ECC RTT with a minimum RTT value from PoP-to-ECC RTTs associated with a PoP in the multitier topology 508. In some embodiments, the second minimum PoP-to-ECC RTT is the PoP-to-ECC RTT with a second minimum RTT value from PoP-to-ECC RTTs associated with the PoP in the multitier topology 508. In some embodiments, the first PoP-to-ECC RTT ECC and the second PoP-to-ECC RTT ECC for each PoP node of PoP nodes 540 map to the “top two” ECCs with the minimum PoP-to-ECC RTTs (or “top two distinct ECCs” when ECC selection unit 410 ensures that the “top two” ECCs are distinct (e.g., not the same ECC in ECCs 130)) in the multitier topology 508, respectively, as described further herein.

### Generating the Pseudo Nodes in the Pseudo Node Topology Using Pseudo Node Generation Unit 573

In some embodiments, with further reference to the multitier topology collapsing unit 571 of FIG. 5A, the pseudo node generation unit 573 is executable code configured to generate pseudo nodes 556 in the pseudo node topology 509 of the edge cloud network 100 using the minimum PoP-to-ECC RTTs of PoP-to-ECC RTTs 504 (e.g., the first minimum PoP-to-ECC RTT and the second minimum PoP-to-ECC RTT) ascertained by the PoP-to-ECC RTT search unit 572. In some embodiments, the pseudo node generation unit 573 generates pseudo nodes 556 by, for each PoP of PoP nodes 540 in the multitier topology 508, grouping each PoP with a first PoP-to-ECC RTT ECC associated with first minimum PoP-to-ECC RTT ascertained by the PoP-to-ECC RTT search unit 572 and a second PoP-to-ECC RTT ECC associated with a second minimum PoP-to-ECC RTT ascertained by the PoP-to-ECC RTT search unit 572, as illustrated in FIG. 5C.

For example, as further illustrated in FIG. 5C, pseudo node generation unit 573 generates pseudo node 541 and pseudo node 542 by grouping PoP node 521 with ECC node 525 and PoP node 521 with ECC node 526, respectively. In some embodiments, in order to generate pseudo node 541 and pseudo node 542, PoP-to-ECC RTT search unit 572 determines PoP-to-ECC RTT 546 to be the first minimum PoP-to-ECC RTT (e.g., first minimum PoP-to-ECC RTT 551) and PoP-to-ECC RTT 547 (illustrated in FIG. 5B) to be the second minimum PoP-to-ECC RTT (e.g., second minimum PoP-to-ECC RTT 552). Pseudo node generation unit 573 generates pseudo node 541 using PoP node 521 and the ECC associated with the first minimum PoP-to-ECC RTT (which in this case is ECC node 525), and generates pseudo node 542 using PoP node 521 and the ECC associated with the first minimum PoP-to-ECC RTT (which in this case is ECC node 525). Multitier topology collapsing unit 571 of ECC selection unit 410 utilizes a similar process for each PoP in PoP nodes 540 to generate the remaining pseudo nodes in pseudo nodes 556.

In some embodiments, after the pseudo nodes 556 have been generated by pseudo node generation unit 573 for each PoP of PoP nodes 540, the pseudo node generation unit 573 completes the transformation process of the multitier topology 508 to the pseudo node topology 509 by extending the RTTs associated with each PoP in the multitier topology 508 to the corresponding ECC in the pseudo nodes 556, as illustrated by way of example in FIG. 5C.

In some embodiments, as stated previously, the pseudo node topology 509 is a topological representation of a transformation of the multitier topology 508 to a pseudo-node-based topological representation that includes pseudo nodes 556 (e.g., pseudo node 541-pseudo node 545) generated by the multitier topology collapsing unit 571, as illustrated by way of example in FIG. 5C. In some embodiments, the pseudo node topology 509 may include the user node (e.g., user node 520), the pseudo node PoPs 597 (e.g., PoP node 521-PoP node 524), and the pseudo-node-based ECCs 599 (e.g., ECC node 525-ECC node 528), such that the PoP nodes 540 and ECC nodes 530 of multitier topology 508 have been transformed into pseudo nodes 556.

### Example Multitier Topology

FIG. 5B illustrates an example of a multitier topology 508 of edge cloud network 100 in accordance with some embodiments. In some embodiments, multitier topology 508 is a multitier topology representation of edge cloud network 100 that is utilized by the ECC selection unit 410 to generate the pseudo node topology 509 in accordance with some embodiments. In some embodiments, the multitier topology 508 is generated by the ECC selection unit 410 based on a list of IP prefixes (e.g., list of IP prefixes 301 represented as, for example, List (IP prefix)) associated with user session requests received from computing devices 110 and utilized by multitier topology collapsing unit 571 to generate pseudo node topology 509. In some embodiments, the list of IP prefixes may be associated with a CCU (e.g., CCUs-per-IP-prefix list 302 and represented as, for example list (IP prefix, #CCU)), described further herein. In some embodiments, as stated previously, the pseudo node topology 509 is utilized to ascertain pseudo-node-selected ECCs 598 of pseudo-node-based ECCs 599 (e.g., pseudo node 541-pseudo node 545).

### Example Pseudo Node Topology

FIG. 5C illustrates an example of a pseudo node topology 509 in accordance with some embodiments. In some embodiments, as stated previously, the pseudo node topology 509 is a topological representation of a transformation of the multitier topology 508 to a pseudo-node-based topological representation that includes pseudo nodes 556 (e.g., pseudo node 541-pseudo node 545) generated by the multitier topology collapsing unit 571. In some embodiments, pseudo node topology 509 is utilized by the ECC selection unit 410 to ascertain pseudo-node-selected ECCs 598 of pseudo-node-based ECCs 599. FIG. 5D and FIG. 5E illustrate the pseudo node topology 509 of FIG. 5C in further detail.

### Ascertaining the Pseudo-Node Selected ECCs by Performing a Search of the Pseudo Node Topology

In some embodiments, the user-to-pseudo-node RTT search unit 574 is executable code configured to search the pseudo node topology 509 generated by the multitier topology collapsing unit 571 to ascertain pseudo-node-selected ECCs 598 of pseudo-node-based ECCs 599 (e.g., pseudo node ECC 541-pseudo node 545). In some embodiments, the pseudo-node-selected ECCs 598 are ECCs selected from pseudo-node-based ECCs 599 of pseudo nodes 556 of the pseudo node topology 509 that map to minimum user-to-pseudo-node RTTs (e.g., a first minimum user-to-pseudo node RTT and a second minimum user-to-pseudo-node RTT) of user-to-pseudo-node RTTs 503 ascertained by user-to-pseudo-node RTT search unit 574, which may be referred to as top X ECCs, where X is the number 2 (e.g., Top2), described further in detail herein. For example, in some embodiments, a first minimum user-to-pseudo node RTT 565 (e.g., first minimum E2E RTT) includes a user-to-PoP RTT 591 and a PoP-to-ECC RTT 551. Similarly, in some embodiments, a second minimum user-to-pseudo node RTT 566 (e.g., second minimum E2E RTT) includes a user-to-PoP RTT 591 and a PoP-to-ECC RTT 552.

In some embodiments, as illustrated in FIG. 5D, user-to-pseudo-node RTTs 503 includes user-to-PoP RTTs 505 and PoP-to-ECC RTTs 504. In some embodiments, the user-to-PoP RTTs 505 are RTTs that extend from user node 520 to pseudo node PoPs 597, as illustrated in FIG. 5E. In some embodiments, the PoP-to-ECC RTTs 504 are the RTTs that extend from pseudo node PoPs 597 to pseudo-node-based ECCs 599, as illustrated in FIG. 5E.

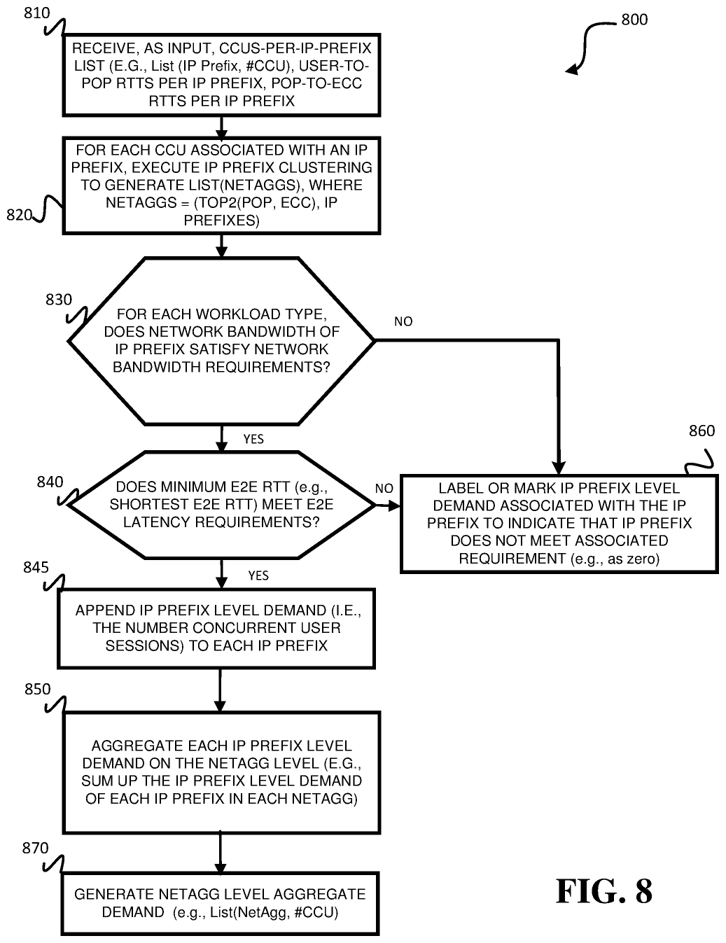

In some embodiments, as stated previously, the user-to-pseudo-node RTT search unit 574 is configured to search the pseudo node topology 509 generated by the pseudo node generation unit 573 of multitier topology collapsing unit 571 to ascertain the pseudo-node-selected ECCs 598 from pseudo-node-based ECCs 599 that are utilized by demand clustering unit 330 to generate the concurrent user sessions per NetAgg 595, as detailed further herein with reference to FIG. 8.

In some embodiments, to ascertain the pseudo-node-selected ECCs 598, the user-to-pseudo-node RTT search unit 574 is configured to perform a user-to-pseudo node RTT assessment of the user-to-pseudo-node RTTs 503 to ascertain the associated pseudo-node-based ECCs with minimum RTT values. Recall that, in some embodiments, the user-to-pseudo-node RTTs 503 includes user-to-PoP RTTs 505 and PoP-to-ECC RTTs 504, as illustrated in FIG. 5D.

In some embodiments, as part of the user-to-pseudo-node RTT assessment, the ECC selection unit 410 assesses user-to-pseudo-node RTTs 503 of the pseudo node topology 509 and selects a first user-to-pseudo-node ECC that maps to a first minimum user-to-pseudo-node RTT of the user-to-pseudo-node RTTs 503 and a second minimum user-to-pseudo-node ECC that maps to a second minimum user-to-pseudo-node RTT of the user-to-pseudo-node RTTs 503. In some embodiments, the first user-to-pseudo-node ECC and the second user-to-pseudo-node ECC map to the top two ECCs with minimum user-to-pseudo node RTTs (e.g., E2E RTTs) from the user node (e.g., IP prefix) to the first user-to-pseudo-node ECC and the second user-to-pseudo-node ECC, respectively.

In some embodiments, ECC selection unit 410 calculates the user-to-pseudo node RTT from the user node to each pseudo node utilizing the following equation:

user-to-pseudo node RTT=user-to-PoP RTT+pseudo-node RTT

where the user-to-PoP RTT is the RTT from the user node to the PoP in the pseudo node topology, the pseudo-node RTT is the RTT from the PoP in the pseudo node to the ECC in the pseudo node, and the user-to-pseudo node RTT is the RTT from the user node to the ECC node in the pseudo node.

In some embodiments, after calculating the user-to-pseudo node RTTs for the pseudo node topology, user-to-pseudo-node RTT search unit 574 compares the values of the user-to-pseudo node RTTS to each other and ascertains the user-to-pseudo node RTTS with a first minimum user-to-pseudo node RTT value and a second minimum user-to-pseudo node RTT value.

In some embodiments, after ascertaining the first minimum user-to-pseudo node RTT value and the second minimum user-to-pseudo node RTT value, the user-to-pseudo-node RTT search unit 574 determines whether the pseudo-node-based ECCs associated with the first minimum user-to-pseudo node RTT value and the second minimum user-to-pseudo node RTT value are not the same pseudo-node-based ECCs (e.g., distinct ECCs). In some embodiments, when user-to-pseudo-node RTT search unit 574 determines that the pseudo-node-based ECCs associated with the first minimum user-to-pseudo node RTT value and the second minimum user-to-pseudo node RTT value are the same pseudo-node-based ECCs (e.g., not distinct), the user-to-pseudo-node RTT search unit 574 does not select the pseudo-node-based ECCs associated with the first minimum user-to-pseudo node RTT value and the second minimum user-to-pseudo node RTT value, but instead repeats the process until determining that the pseudo-node-based ECCs associated with the first minimum user-to-pseudo node RTT value and the second minimum user-to-pseudo node RTT value are not the same pseudo-node-based ECCs.

In some embodiments, when user-to-pseudo-node RTT search unit 574 determines that the pseudo-node-based ECCs associated with the first minimum user-to-pseudo node RTT value and the second minimum user-to-pseudo node RTT value are not the same pseudo-node-based ECCs, the user-to-pseudo-node RTT search unit 574 selects the pseudo-node-based ECCs associated with the first minimum user-to-pseudo node RTT value (e.g., a first pseudo-node-selected ECC) and the second minimum user-to-pseudo node RTT value (e.g., a second pseudo-node-selected ECC). In some embodiments, user-to-pseudo-node RTT search unit 574 determines the first pseudo-node-selected ECC and the second pseudo-node-selected ECC associated with each IP prefix.

In some embodiments, the ECC selection unit 410 is configured to provide the first pseudo-node-selected ECC and second pseudo-node-selected ECC associated with each IP prefix to the IP prefix clustering unit 420 of demand clustering unit 330. In some embodiments, ECC selection unit 410 is configured to provide the first pseudo-node-selected ECC and second pseudo-node-selected ECC associated with each IP prefix as a list of IP-prefixes-with-top-two ECCs 611 (e.g., a list of IP prefixes that represent the pseudo-node-selected ECCs 598 (e.g., top two ECCs) selected for each IP prefix by ECC selection unit 410) to the IP prefix clustering unit 420.

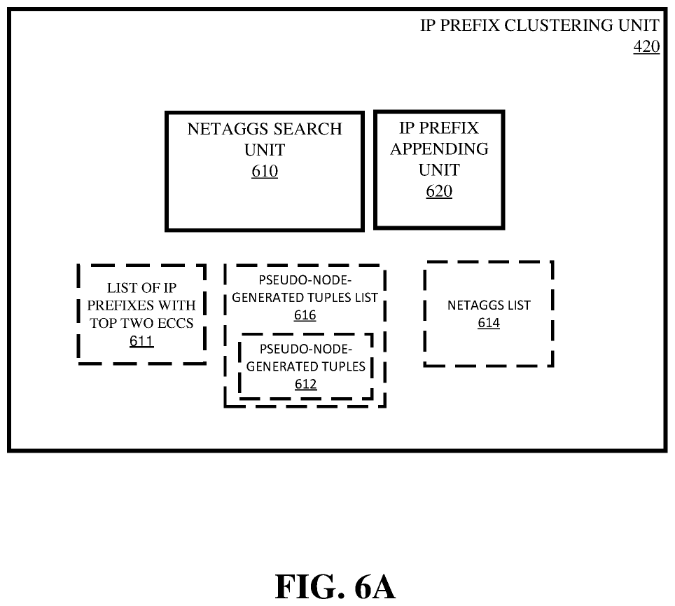

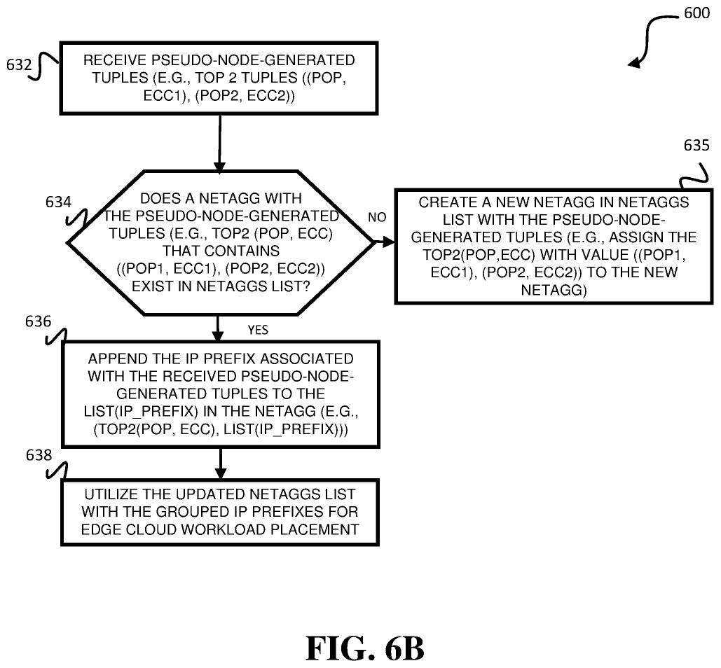

In some embodiments, ECC selection unit 410 provides the results (e.g., the list of IP-prefixes-with-top-two ECCs) as pseudo-node-generated tuples 612 in a pseudo-node-generated tuples list 616 (e.g., a list of pseudo-node-generated tuples 612) to IP prefix clustering unit 420. In some embodiments, the pseudo-node-generated tuples list 616 is a list of pseudo-node-generated tuples 612 that represent the pseudo-node-selected ECCs 598 (and the PoPs associated with the pseudo-node-selected ECCs 598) selected for each IP prefix by ECC selection unit 410. In some embodiments, the pseudo-node-generated tuples 612 may represent the pseudo-node-selected ECCs 598 and the PoPs associated with the pseudo-node-selected ECCs 598 and be in the format of, for example, (PoP, ECC) that includes (PoP1, ECCA) and (PoP2, ECCB), where PoP1 is a PoP associated with the pseudo-node-selected ECCA, and PoP2 is a PoP associated with the pseudo-node-selected ECCB. For example, ECC selection unit 410 generates and provides the pseudo-node-generated tuples 612 to IP prefix clustering unit 420, illustrated in further detail in FIG. 6A.

FIG. 5F illustrates an ECC selection method 500 utilized by the demand clustering-based workload placement system of FIG. 3A in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments.

In some embodiments, at operation 512, ECC selection unit 410 receives the list of IP prefixes 301. In some embodiments, at operation 513, based on the list of IP prefixes 301, ECC selection unit 410 generates a pseudo node topology 509 from a multitier topology 508 of the edge cloud network 100. In some embodiments, at operation 514, for each IP prefix in the list of IP prefixes 301, ECC selection unit 410 searches for user-to-pseudo-node ECCs with minimum user-to-pseudo-node RTTs from the user node to the pseudo node. In some embodiments, at operation 516, the user-to-pseudo-node ECCs selected by the ECC selection unit 410 are utilized in edge cloud workload placement by demand clustering-based edge cloud workload placement system 230.

FIG. 6A illustrates IP prefix clustering unit 420 in accordance with some embodiments. In some embodiments, IP prefix clustering unit 420 is executable code configured to group IP prefixes that have equivalent top two ECCs into a NetAgg of a NetAggs list 614 for edge cloud workload placement. In some embodiments, IP prefix clustering unit 420 includes a NetAgg search unit 610 and IP prefix appending unit 620. In some embodiments, NetAgg search unit 610 is executable code configured to search a NetAggs list 614 to determine whether a received pseudo-node-generated tuples 612 associated with an IP prefix matches with pseudo-node-generated tuples in a NetAgg of NetAggs list 614. In some embodiments, the pseudo-node-generated tuples in a NetAgg of NetAggs list 614 may be associated with a single IP prefix or a plurality of IP prefixes. In some embodiments, IP prefix appending unit 620 is executable code configured to append an IP prefix associated with pseudo-node-generated tuples 612 to the NetAgg that has the pseudo-node-generated tuples in NetAggs list 614 that match with the received pseudo-node-generated tuples 612. In some embodiments, the matching of the pseudo-node-generated tuples by NetAgg search unit 610 allows for the grouping of IP prefixes that have the same top X ECCs (where, X is a natural number greater than one (e.g., 2)) for edge cloud workload placement by workload placement engine 310.

In some embodiments, NetAgg search unit 610 receives pseudo-node-generated tuples 612 from a pseudo-node-generated tuples list 616 from ECC selection unit 410. In some embodiments, as stated previously, the pseudo-node-generated tuples list 616 are a list of pseudo-node-generated tuples 612. In some embodiments, the pseudo-generated tuples in pseudo-node-generated tuples 612 represent the pseudo-node-selected ECCs 598 (and the PoPs associated with the pseudo-node-selected ECCs 598) selected for each IP prefix by ECC selection unit 410. Further, in some embodiments, the pseudo-node-generated tuples 612 are in the format of, for example, (PoP, ECC) that includes (PoP1, ECCA) and (PoP2, ECCB), where PoP1 is a PoP associated with the pseudo-node-selected ECCA, and PoP2 is a PoP associated with the pseudo-node-selected ECCB.

In some embodiments, after receiving the pseudo-node-generated tuples 612, NetAgg search unit 610 determines whether the pseudo-node-generated tuples 612 match with pseudo-node-generated tuples in NetAggs list 614 (e.g., a list of NetAggs that includes NetAggs previously placed in NetAggs list 614). In some embodiments, the NetAgg search unit 610 determines whether the pseudo-node-generated tuples 612 match with the pseudo-node-generated tuples in NetAggs list 614 by comparing the received pseudo-node-generated tuples 612 to the pseudo-node-generated tuples that are in the NetAggs list 614. In some embodiments, when the received pseudo-node-generated tuples 612 do not match with pseudo-node-generated tuples in NetAggs list 614 (e.g., is not in NetAggs list 614), NetAgg search unit 610 creates a new NetAgg in NetAggs list 614 with the pseudo-node-generated tuples 612 that includes an empty IP prefix list (e.g., an empty List(IP Prefix)).

In some embodiments, when NetAgg search unit 610 determines that the received pseudo-node-generated tuples 612 match with pseudo-node generated tuples in the NetAggs list 614, IP prefix appending unit 620 appends the IP prefix associated with the received pseudo-node-generated tuples 612 to the NetAgg of NetAggs list 614 that includes the matching pseudo-node-generated tuples. In some embodiments, as a result of appending the IP prefix to the NetAgg of NetAggs list 614, the IP prefix associated with the received pseudo-node-generated tuples 612 is grouped with the IP prefix associated with pseudo-node-generated tuples of the associated NetAgg of NetAggs list 614 that have the same top X ECCs. In some embodiments, the resulting NetAggs list 614 with the grouped IP prefixes may be utilized for efficient workload placement by workload placement engine 310.

FIG. 6B illustrates an IP prefix clustering method 600 performed by the IP prefix clustering unit 420 in accordance with some embodiments. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments.

In some embodiments, at operation 632, NetAgg search unit 610 receives pseudo-node-generated tuples 612 from user-to-pseudo-node RTT search unit 574 of ECC selection unit 410. In some embodiments, a first pseudo-node-generated tuple of the pseudo-node-generated tuples 612 may be represented as ((PoP1, ECCA) and a second pseudo-node-generated tuple of pseudo-node-generated tuples 612 may represented as (PoP2, ECCB)), where PoP1 is a PoP associated with the pseudo-node-selected ECCA, and PoP2 is a PoP associated with the pseudo-node-selected ECCB. In some embodiments, after receiving the pseudo-node-generated tuples 612, operation 632 proceeds to operation 634.

In some embodiments, at operation 634, NetAgg search unit 610 determines whether a NetAgg exists in NetAggs list 614 that includes the pseudo-node-generated tuples 612 (e.g., Top2(PoP, ECC) that contains ((PoP1, ECC1), (PoP2, ECC2))) received from ECC selection unit 410. In some embodiments, at operation 635, when NetAgg search unit 610 determines that a NetAgg does not exist in NetAggs list 614 that includes the pseudo-node-generated tuples 612, IP prefix clustering unit 420 creates a new NetAgg in NetAggs list 614 with the received pseudo-node-generated tuples 612 from ECC selection unit 410. In some embodiments, at operation 636, when NetAgg search unit 610 determines that a NetAgg does exist in NetAggs list 614 that includes the received pseudo-node-generated tuples 612, IP prefix appending unit 620 appends the IP prefix associated with the received pseudo-node-generated tuples 612 to the NetAgg of NetAggs list 614 that includes the matching pseudo-node-generated tuples. In some embodiments, operations 636 proceeds to operation 638.

In some embodiments, at operation 638, the updated dated NetAggs list 614 with the grouped IP prefixes may be utilized for demand forecasting at, for example, demand forecasting unit 340, demand NetAgg adjustment at, for example, demand NetAggs adjustment unit 430, and edge cloud workload placement at workload placement engine 310.

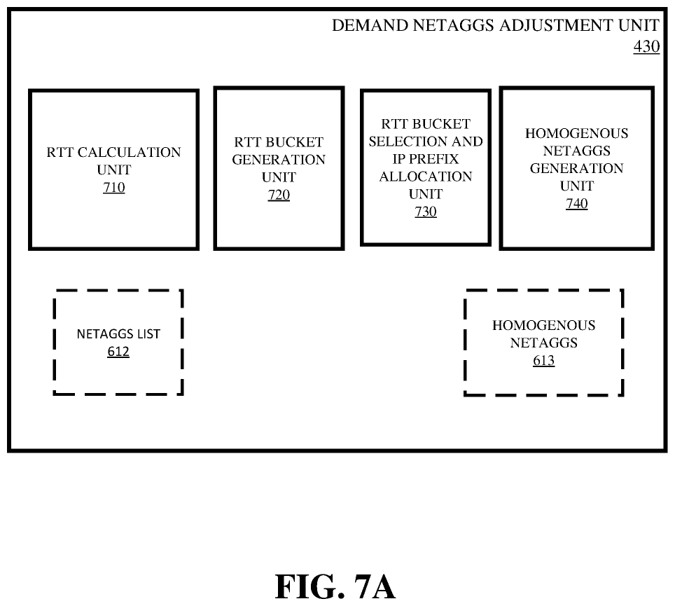

FIG. 7A illustrates demand NetAggs adjustment unit 430 in accordance with some embodiments. In some embodiments, demand NetAggs adjustment unit 430 is executable code configured to adjust the demand clustering results (e.g., NetAggs list 614) received from IP prefix clustering unit 420 to reduce RTT variance within a NetAgg of NetAggs list 614. In some embodiments, the RTT variance is reduced to prevent the RTT variance from exceeding a homogenous NetAggs RTT variance threshold that prevents the RTT difference from being excessive. In some embodiments, the homogenous NetAggs RTT variance threshold may be defined such that an RTT difference is less than, for example, twenty milliseconds (RTT difference is <20 ms, where 20 ms is the homogenous NetAggs RTT variance threshold). In some embodiments, the RTT is reduced in order for workload placement engine 310 to utilize the same demand NetAggs 331 to place different edge cloud workloads with different RTT requirements on demand-cluster-selected ECCs of ECCs 130 of edge cloud network 100.

In some embodiments, in order to reduce RTT variance within a NetAgg of NetAggs list 614, demand NetAggs adjustment unit 430 utilizes an approach of splitting the generated NetAggs in NetAggs list 614 with large RTT differences (assessed utilizing the homogenous NetAggs RTT variance threshold) into homogenous groups (e.g., homogenous NetAggs 613). In some embodiments, in order to generate the homogenous NetAggs 613, demand NetAggs adjustment unit 430 includes an RTT calculation unit 710, an RTT bucket generation unit 720, an RTT bucket selection and IP prefix allocation unit 730, and homogenous NetAggs generation unit 740. In some embodiments, homogenous NetAggs 613 are generated for each NetAgg in NetAggs list 614.

In some embodiments, RTT calculation unit 710 is executable code configured to calculate a minimum RTT and maximum RTT, where the minimum RTT is the minimum RTT utilized by the RTT calculation unit 710 to create an RTT bucket and the maximum RTT is the maximum RTT utilized by the RTT calculation unit 710 to create an RTT bucket, described further herein.

In some embodiments, RTT bucket generation unit 720 is executable code configured to utilize the minimum RTT and a maximum RTT to generate an RTT bucket. In some embodiments, RTT bucket generation unit 720 generates RTT buckets as:

Min_RTT+20 ms, Min_RTT+20 ms*2, . . . . Min_RTT+20 ms*N, where Min_RTT+20 ms*(N+1)>Max_RTT

where MIN_RTT is the minimum RTT, Max_RTT is the maximum RTT and N is the number of RTT buckets.

In some embodiments, RTT bucket selection and IP prefix allocation unit 730 is executable code configured to select the RTT bucket and allocate an IP prefix based on an average RTT from the IP prefix to the Top2 ECC. For example, in some embodiments, for each IP prefix inside a NetAgg, RTT bucket selection and IP prefix allocation unit 730 selects the RTT bucket and allocates the IP prefix to the RTT bucket when an average RTT from the IP prefix to the Top2 ECC in the NetAgg “fits the best” in the RTT bucket (e.g., satisfies a best fit RTT bucket criteria). In some embodiments, the best fit RTT bucket criteria is satisfied when the average RTT is less than the RTT bucket and the average RTT is greater than the RTT bucket minus twenty milliseconds (e.g., AVG_RTT<RTT_bucket, and AVG_RTT>RTT bucket−20 ms, where AVG_RTT is the average RTT and RTT_bucket is the value associated with the RTT bucket).

In some embodiments, homogenous NetAggs generation unit 740 is executable code configured to generate homogenous NetAggs 613 generated based upon the adjustment of NetAggs list 614. In some embodiments, homogenous NetAggs generation unit 740 generates the homogenous NetAggs 613 by copying the top two paths information from the original NetAgg of the NetAggs list 614 to the RTT buckets generated using the RTT bucket generation unit 720. In some embodiments, the homogenous NetAggs 613 may be represented as the demand NetAggs 331 that are provided to demand forecasting unit 340 for use in edge cloud workload placement by workload placement engine 310 in demand-cluster-selected ECCs of ECCs 130 of edge cloud network 100, as described herein.

FIG. 8 illustrates an E2E demand clustering method 800 in accordance with some embodiments. In some embodiments, the E2E demand clustering method 800 is utilized by demand clustering-based edge cloud workload placement system 230 to generate a NetAgg level aggregated demand for edge cloud workload placement of edge cloud workloads in edge cloud network 100. The method, process steps, or stages illustrated in the figures may be implemented as an independent routine or process, or as part of a larger routine or process. Note that each process step or stage depicted may be implemented as an apparatus that includes a processor executing a set of instructions, a method, or a system, among other embodiments.

In some embodiments, at operation 810, demand clustering unit 330 receives, as input, a concurrent-user-sessions (CCUs)-per-IP-prefix list 302, an RTT of each IP prefix to each edge PoP of edge PoPs 120 (e.g., user-to-PoP RTTs 558 for each IP prefix), an RTT between edge PoPs 120 and ECCs 130 (e.g., PoP-to-ECC RTTs 557 for each IP prefix), and an IP-prefix-network-bandwidth 303. In some embodiments, a CCUs-per-IP prefix indicates concurrent user sessions per IP prefix (e.g., originating from a specific IP prefix) in edge cloud network 100. In some embodiments, CCUs-per-IP-prefix list 302 is a list of CCUs per IP prefix that may be represented as, for example, list (IP prefix, #CCU)). In some embodiments, IP-prefix-network-bandwidth 303 is a network bandwidth associated with an IP prefix in edge cloud network 100. In some embodiments, operation 810 proceeds to operation 820.

In some embodiments, at operation 820, for each CCU associated with an IP prefix in CCUs-per-IP-prefix list 302, demand clustering unit 330 utilizes IP prefix clustering unit 420 to generate NetAggs list 614 (e.g., a list of the NetAggs represented as, for example, List(NetAggs), where NetAggs=(ToP2(PoP, ECC), IP Prefixes)). In some embodiments, after NetAggs list 614 (e.g., List(NetAggs)) is generated by demand clustering unit 330, operation 820 proceeds to operation 830.

In some embodiments, at operation 830, for each workload type in NetAggs list 614, demand clustering unit 330 determines whether an IP-prefix-network-bandwidth 303 associated with an IP prefix of a NetAgg of NetAggs list 614 satisfies the network bandwidth requirement of the workload (e.g., network throughput bandwidth requirement). In some embodiments, the network bandwidth of the workload may be measured utilizing goodput (e.g., effective data transfer rate). In some embodiments, when demand clustering unit 330 determines that the IP-prefix-network-bandwidth 303 associated with an IP prefix in a NetAgg of NetAggs list 614 does not satisfy the network bandwidth requirement, at operation 860, demand clustering unit 330 labels the IP prefix level demand associated with the IP prefix to indicate that the network bandwidth of the IP prefix does not satisfy the network bandwidth requirement. For example, demand clustering unit 330 labels (marks or flags) the IP prefix level demand associated with the IP prefix with a zero to indicate that the IP prefix does not satisfy the network bandwidth requirement.

In some embodiments, at operation 840, when demand clustering unit 330 determines that the IP-prefix-network-bandwidth 303 associated with an IP prefix of a NetAgg of NetAggs list 614 does satisfy the network bandwidth requirements, demand clustering unit 330 determines whether a minimum E2E RTT associated with the IP prefix in the NetAgg of NetAggs list 614 satisfies an E2E latency requirement. In some embodiments, the E2E latency requirement is a maximum E2E RTT (e.g., maximum RTT between user node, edge PoP node, and ECC node) allowed by demand clustering-based edge cloud workload placement system 230.

In some embodiments, when demand clustering unit 330 determines that the minimum E2E RTT associated with the IP prefix in the NetAgg of NetAggs list 614 does not satisfy the E2E latency requirement, at operation 860, demand clustering unit 330 labels the IP prefix level demand associated with the IP prefix to indicate that E2E latency requirement is not satisfied.

In some embodiments, when demand clustering unit 330 determines that the minimum E2E RTT associated with the IP prefix in the NetAgg of NetAggs list 614 satisfies the E2E latency requirement, at operation 845, demand clustering unit 330 appends IP prefix level demand (i.e., the number of concurrent user sessions (e.g., #CCUs)) to each IP prefix. In some embodiments, demand clustering unit 330 appends IP prefix level demand to each prefix from the associated IP prefix in CCUs-per-IP-prefix list 302. In some embodiments, at operation 850, demand clustering unit 330 aggregates each IP prefix level demand on the NetAgg level. For example, in some embodiments, demand clustering unit 330 sums up the IP prefix level demand of each IP prefix in each NetAgg of NetAggs list 614, which is concurrent user sessions per NetAgg 595. In some embodiments, at operation 870, demand clustering unit 330 generates a NetAgg level aggregate demand (e.g., List (NetAgg, #CCUs per NetAgg) or List (NetAgg, #CCU) as demand clustering results ((e.g., demand NetAggs 331 represented as, for example, List (NetAgg, #CCU)) for edge cloud workload placement by workload placement engine 310 of demand clustering-based edge cloud workload placement system 230 of edge cloud network 100.

In some embodiments, utilizing the demand clustering-based edge cloud workload placement system 230 described herein provides significant improvements over other edge cloud workload placement systems in that, for example, for a given NetAgg (generated utilizing demand clustering-based edge cloud workload placement system 230), a list of ECC candidates (e.g., demand-cluster-selected ECCs of ECCs 130) for placing workloads is provided that minimizes E2E latency (e.g., are ECCs with top two shortest E2E latency associated with an IP prefix). Furthermore, the NetAggs provided by demand clustering-based edge cloud workload placement system 230 are balanced in terms of demand. In some embodiments, by utilizing the demand balance provided by demand clustering-based edge cloud workload placement system 230, compared to other edge cloud workload placement systems, it is easier for workload placement engine 310 to achieve load balancing amongst ECCs 130, it is easier for demand prediction based on the generated NetAggs (reduces difficulty and complication in prediction accuracy), and it minimizes the gap between edge cloud workload placement and real-time targeting decisions. Thus, by utilizing the edge compute workload placement operations provided by demand clustering-based edge cloud workload placement system 230, applications executed by the computing devices utilized by the end user of edge cloud network 100 benefit from reduced latency, enhanced privacy, improved reliability, and bandwidth optimization, as exemplified herein.

In some embodiments, a computer-implemented method includes ascertaining a multitier topology representation of an edge cloud network; generating a pseudo node topology representation of the edge cloud network from the multitier topology representation; and utilizing the pseudo node topology representation of the edge cloud network to ascertain pseudo-node-selected edge cloud clusters (ECCs) from pseudo-node-based ECCs, the pseudo-node-selected ECCs being utilized to route user requests through the edge cloud network from a user of the edge cloud network.

In some embodiments of the computer-implemented method, the pseudo-node-selected ECCs are minimum-latency pseudo-node-based ECCs, the minimum-latency pseudo-node-based ECCs being ascertained based upon a pseudo-node-based round-trip-times (RTTs) assessment of pseudo-node-based RTTs of the user requests requested from the user of the edge cloud network.

In some embodiments of the computer-implemented method, the pseudo-node-based RTTs assessment includes determining a first minimum pseudo-node-based RTT of the pseudo-node-based RTTs and a second minimum pseudo-node-based RTT of the pseudo-node-based RTTs from a user node associated with the user of the edge cloud network to pseudo nodes of the pseudo node topology representation.

In some embodiments of the computer-implemented method, the multitier topology representation includes at least the user node, a plurality of point-of-presence (PoP) nodes, and a plurality of edge cloud clusters (ECCs).

In some embodiments of the computer-implemented method, the pseudo node topology representation is generated by transforming the multitier topology representation to the pseudo node topology representation.

In some embodiments of the computer-implemented method, the multitier topology representation is transformed to the pseudo node topology representation by collapsing the multitier topology representation to a single tier topology representation.

In some embodiments of the computer-implemented method, collapsing the multitier topology representation to the single tier topology representation includes generating the pseudo nodes from the plurality of PoP nodes and the plurality of ECCs of the multitier topology representation.

In some embodiments of the computer-implemented method, a pseudo node of the pseudo nodes is generated using a PoP node of the PoP nodes and an ECC from the plurality of ECCs of the multitier topology representation based upon a PoP-to-ECC round trip time (RTT) assessment of PoP-to-ECC RTTs from the PoP node to the plurality of ECCs.

In some embodiments of the computer-implemented method, the first minimum pseudo-node-based RTT of the pseudo-node-based RTTs from the user of the edge cloud network to pseudo nodes of the pseudo node topology representation represents a first minimum end-to-end (E2E) RTT and the second minimum pseudo-node-based RTT of the pseudo-node-based RTTs from the user of the edge cloud network to pseudo nodes of the pseudo node topology representation represents a second minimum E2E RTT.

In some embodiments, a system includes a processor; and a non-transitory computer readable medium coupled to the processor, the non-transitory computer readable medium including code that: ascertains a multitier topology representation of an edge cloud network; generates a pseudo node topology representation of the edge cloud network from the multitier topology representation; and utilizes the pseudo node topology representation of the edge cloud network to ascertain minimum-latency pseudo-node-based edge cloud clusters (ECCs), the minimum-latency pseudo-node-based ECCs being utilized to minimize a latency of user requests routed through the edge cloud network from a user of the edge cloud network.

In some embodiments of the system, the minimum-latency pseudo-node-based ECCs are ascertained based upon a pseudo-node-based round-trip-times (RTTs) assessment of pseudo-node-based RTTs of the user requests requested from the user of the edge cloud network, the user requests being routed to the minimum-latency pseudo-node-based ECCs ascertained using the pseudo node topology representation.

In some embodiments of the system, the pseudo-node-based RTTs assessment includes determining a first minimum pseudo-node-based RTT of the pseudo-node-based RTTs and a second minimum pseudo-node-based RTT of the pseudo-node-based RTTs from a user node associated with the user of the edge cloud network to pseudo nodes of the pseudo node topology representation.

In some embodiments of the system, the pseudo node topology representation is generated by transforming the multitier topology representation to the pseudo node topology representation.

In some embodiments of the system, the multitier topology representation is transformed to the pseudo node topology representation by collapsing the multitier topology representation to a single tier topology representation.

In some embodiments of the system, collapsing the multitier topology representation to the single tier topology representation includes generating the pseudo nodes from a plurality of point-of-presence (PoP) nodes and a plurality of ECCs of the multitier topology representation.

In some embodiments of the system, a pseudo node of the pseudo nodes is generated using a PoP node of the PoP nodes and an ECC of the plurality of ECCs of the multitier topology representation based upon a PoP-to-ECC round trip time (RTT) assessment of PoP-to-ECC RTTs from the PoP node to the ECCs.

In some embodiments, an edge cloud cluster selection unit includes a multitier collapsing unit; and a user-to-pseudo node search unit, wherein the multitier collapsing unit is configured to transform a multitier topology representation of an edge cloud network to a pseudo node topology representation of the edge cloud network, the pseudo node topology representation being utilized by the edge cloud cluster selection unit to route user requests to edge cloud clusters (ECCs) ascertained using the pseudo node topology representation.

In some embodiments of the edge cloud cluster selection unit, the user-to-pseudo node search unit utilizes the pseudo node topology representation of the edge cloud network to ascertain the ECCs based upon a pseudo-node-based round-trip-times (RTTs) assessment of pseudo-node-based RTTs of user requests requested from a user of the edge cloud network, the user requests being routed to the ECCs ascertained using the pseudo node topology representation.

In some embodiments of the edge cloud cluster selection unit, the pseudo-node-based RTTs assessment includes determining a first minimum pseudo-node-based RTT of the pseudo-node-based RTTs and a second minimum pseudo-node-based RTT of the pseudo-node-based RTTs from the user of the edge cloud network to pseudo nodes of the pseudo node topology representation.

In some embodiments of the edge cloud cluster selection unit, the multitier collapsing unit is utilized to transform the multitier topology representation to the pseudo node topology representation by collapsing the multitier topology representation to a single tier topology representation.

What is claimed is:

1. A computer-implemented method, comprising:
ascertaining a multitier topology representation of an edge cloud network;
generating a pseudo node topology representation of the edge cloud network from the multitier topology representation; and
utilizing the pseudo node topology representation of the edge cloud network to ascertain pseudo-node-selected edge cloud clusters (ECCs) from pseudo-node-based ECCs, the pseudo-node-selected ECCs being utilized to route user requests through the edge cloud network from a user of the edge cloud network.

2. The computer-implemented method of claim 1, wherein:
the pseudo-node-selected ECCs are minimum-latency pseudo-node-based ECCs, the minimum-latency pseudo-node-based ECCs being ascertained based upon a pseudo-node-based round-trip-times (RTTs) assessment of pseudo-node-based RTTs of the user requests requested from the user of the edge cloud network.

3. The computer-implemented method of claim 2, wherein:
the pseudo-node-based RTTs assessment includes determining a first minimum pseudo-node-based RTT of the pseudo-node-based RTTs and a second minimum pseudo-node-based RTT of the pseudo-node-based RTTs from a user node associated with the user of the edge cloud network to pseudo nodes of the pseudo node topology representation.

4. The computer-implemented method of claim 3, wherein:
the multitier topology representation includes at least the user node, a plurality of point-of-presence (PoP) nodes, and a plurality of edge cloud clusters (ECCs).

5. The computer-implemented method of claim 4, wherein:
the pseudo node topology representation is generated by transforming the multitier topology representation to the pseudo node topology representation.

6. The computer-implemented method of claim 5, wherein:
the multitier topology representation is transformed to the pseudo node topology representation by collapsing the multitier topology representation to a single tier topology representation.

7. The computer-implemented method of claim 6, wherein:
collapsing the multitier topology representation to the single tier topology representation includes generating the pseudo nodes from the plurality of PoP nodes and the plurality of ECCs of the multitier topology representation.

8. The computer-implemented method of claim 7, wherein:
a pseudo node of the pseudo nodes is generated using a PoP node of the PoP nodes and an ECC from the plurality of ECCs of the multitier topology representation based upon a PoP-to-ECC round trip time (RTT) assessment of PoP-to-ECC RTTs from the PoP node to the plurality of ECCs.

9. The computer-implemented method of claim 8, wherein:
the first minimum pseudo-node-based RTT of the pseudo-node-based RTTs from the user of the edge cloud network to the pseudo nodes of the pseudo node topology representation represents a first minimum end-to-end (E2E) RTT and the second minimum pseudo-node-based RTT of the pseudo-node-based RTTs from the user of the edge cloud network to the pseudo nodes of the pseudo node topology representation represents a second minimum E2E RTT.

10. A system, comprising:
a processor; and
a non-transitory computer readable medium coupled to the processor, the non-transitory computer readable medium including code that:
ascertains a multitier topology representation of an edge cloud network;
generates a pseudo node topology representation of the edge cloud network from the multitier topology representation; and
utilizes the pseudo node topology representation of the edge cloud network to ascertain minimum-latency pseudo-node-based edge cloud clusters (ECCs), the minimum-latency pseudo-node-based ECCs being utilized to minimize a latency of user requests routed through the edge cloud network from a user of the edge cloud network.

11. The system of claim 10, wherein:
the minimum-latency pseudo-node-based ECCs are ascertained based upon a pseudo-node-based round-trip-times (RTTs) assessment of pseudo-node-based RTTs of the user requests requested from the user of the edge cloud network, the user requests being routed to the minimum-latency pseudo-node-based ECCs ascertained using the pseudo node topology representation.

12. The system of claim 11, wherein:
the pseudo-node-based RTTs assessment includes determining a first minimum pseudo-node-based RTT of the pseudo-node-based RTTs and a second minimum pseudo-node-based RTT of the pseudo-node-based RTTs from a user node associated with the user of the edge cloud network to pseudo nodes of the pseudo node topology representation.

13. The system of claim 12, wherein:
the pseudo node topology representation is generated by transforming the multitier topology representation to the pseudo node topology representation.

14. The system of claim 13, wherein:
the multitier topology representation is transformed to the pseudo node topology representation by collapsing the multitier topology representation to a single tier topology representation.

15. The system of claim 14, wherein:
collapsing the multitier topology representation to the single tier topology representation includes generating the pseudo nodes from a plurality of point-of-presence (PoP) nodes and a plurality of ECCs of the multitier topology representation.

16. The system of claim 15, wherein:
a pseudo node of the pseudo nodes is generated using a PoP node of the PoP nodes and an ECC of the plurality of ECCs of the multitier topology representation based upon a PoP-to-ECC round trip time (RTT) assessment of PoP-to-ECC RTTs from the PoP node to the ECCs.

17. An edge cloud cluster selection unit, comprising:
a multitier collapsing unit; and
a user-to-pseudo node search unit, wherein the multitier collapsing unit is configured to transform a multitier topology representation of an edge cloud network to a pseudo node topology representation of the edge cloud network, the pseudo node topology representation being utilized by the edge cloud cluster selection unit to route user requests to edge cloud clusters (ECCs) ascertained using the pseudo node topology representation.

18. The edge cloud cluster selection unit of claim 17, wherein:
the user-to-pseudo node search unit utilizes the pseudo node topology representation of the edge cloud network to ascertain the ECCs based upon a pseudo-node-based round-trip-times (RTTs) assessment of pseudo-node-based RTTs of user requests requested from a user of the edge cloud network, the user requests being routed to the ECCs ascertained using the pseudo node topology representation.

19. The edge cloud cluster selection unit of claim 18, wherein:
the pseudo-node-based RTTs assessment includes determining a first minimum pseudo-node-based RTT of the pseudo-node-based RTTs and a second minimum pseudo-node-based RTT of the pseudo-node-based RTTs from the user of the edge cloud network to pseudo nodes of the pseudo node topology representation.

20. The edge cloud cluster selection unit of claim 19, wherein:
the multitier collapsing unit is utilized to transform the multitier topology representation to the pseudo node topology representation by collapsing the multitier topology representation to a single tier topology representation.
